(19) United States
(12) Patent Application Publication
(10) Pub. No.: US 2004/0137159 A1
(43) Pub. Date: Jul. 15, 2004

(54) Method of, and apparatus for, sucking function liquid droplet ejection head; liquid droplet ejection apparatus; method of manufacturing electrooptic device; electrooptic device; and electronic equipment

(76) Inventors: Shinichi Nakamura, Okaya-shi (JP); Yoshiaki Yamada, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/705,773

(22) Filed: Nov. 11, 2003

(30) Foreign Application Priority Data
Nov. 12, 2002 (JP) 2002-328793
Jul. 31, 2003 (JP) 2003/204394

(51) Int. Cl. B05D 5/12; B05D 1/02; B05C 11/00

(52) U.S. Cl. 427/421; 427/58; 118/692

(57) ABSTRACT

An apparatus for sucking a function liquid droplet ejection head has an ejector and an arrangement for supplying the ejector with a working fluid. A cap is brought into close contact with a nozzle surface of the function liquid droplet ejection head, and the ejector is operated to thereby suck the nozzle surface through the cap by means of the working fluid.

### BACKGROUND OF THE INVENTION

1. Field of the Invention

The present invention relates to: a method of, and apparatus for, sucking a function liquid (or functional liquid) droplet ejection (or discharge) head which performs suction of the function liquid droplet ejection head through caps by allowing the caps to adhere to the function liquid droplet ejection head; a liquid droplet ejection apparatus; a method of manufacturing an electrooptic device; an electrooptic device; and an electronic equipment.

2. Description of the Related Art

In an ink jet recording apparatus conventionally known as a kind of liquid droplet ejection apparatus, an ink pump is driven while allowing a head cap (cap) connected to an ink pump to adhere to a printing head (a function liquid droplet ejection head) and thus suction of ink from all nozzles of the printing head is performed via the head cap.

In the liquid droplet ejection apparatus, suction is performed from all nozzles of the function liquid droplet ejection head in cleaning for preventing clogging of the printing head due to drying and the like and in filling (initial filling of) a function liquid into a passage inside a newly installed function liquid droplet ejection head.

When the suction is performed from the function liquid droplet ejection head, air (bubbles) is sucked from the passage prior to the function liquid. Therefore, when the suction for the function liquid droplet ejection head is performed by using the pump as described in the foregoing ink jet recording apparatus, there arises a problem that the pump runs idle till the sucked air is discharged from the pump. Such a problem is particularly significant in the case of filling the newly installed function liquid droplet ejection head with the function liquid. In such a case, a sufficient suction force cannot be ensured until the function liquid reaches the pump and thus the filling of the function liquid takes long. Moreover, a discharging property of the bubbles from the passage inside the head is deteriorated because of the lowered suction force. Thus, an amount of consumption of the function liquid required in filling thereof is increased, resulting in a problem of wasting the expensive function liquid. Furthermore, the pump includes a rotating component and a component which moves back-and-forth (a movable part) and thus miniaturization thereof is hard and installation thereof requires a large space.

### SUMMARY OF THE INVENTION

The present invention was made in consideration of the foregoing problems. It is an advantage of the present invention to provide a method of, and apparatus for efficiently sucking a function liquid droplet ejection; a liquid droplet ejection apparatus; a method of manufacturing an electrooptic device; an electrooptic device; and an electronic equipment.

The method of sucking a function liquid droplet ejection head according to the present invention comprises the steps of bringing a cap into close contact with a nozzle surface of the function liquid droplet ejection head which ejects (or discharges) function liquid droplets, and sucking the nozzle surface by an ejector.

According to the above-described arrangement, nozzles of the function liquid droplet ejection head are sucked by using the ejector, and thereby a suction force can be directly applied to the function liquid and air preceding the function liquid. Hence, unlike the case of performing suction by using a pump, air leakage does not occur. Specifically, bubbles entering the ejector through the cap are smoothly discharged together with a working fluid of the ejector, and thus there is less fluctuation in a suction pressure due to the bubbles. Therefore, the suction from the nozzles of the function liquid droplet ejection head can be stably performed. The suction may be performed for all the nozzles or may be performed only for the nozzles to be used.

In this case, in order to have a constant suction pressure in a suction pipeline from the cap to a suction port of the ejector, preferably the flow rate of a working fluid supplied to the ejector is controlled.

According to this arrangement, by controlling the flow rate of the working fluid supplied to the ejector, the suction pressure in the suction pipeline can be maintained constant. Thus, the suction from the function liquid droplet ejection head can be performed. For example, even in the case where the bubbles and the liquid are sucked and passage resistance is different for bubbles and liquid like the case of initial filling of the function liquid, pressure fluctuation in the suction pipeline can be minimized by controlling the flow rate of the working fluid. Thus, the suction force to the function liquid droplet ejection head is never impaired.

Preferably, a suction pipeline from the cap to the ejector is opened to atmosphere when suction of the function liquid droplet ejection head is finished.

According to this arrangement, when the suction operation for the function liquid droplet ejection head is finished, the pressure in the suction pipeline is released, i.e., the suction pipeline is opened to atmospheric pressure. Therefore, the function liquid left in the suction pipeline can be completely discharged through the ejector. Hence, it is possible to prevent clogging and the like caused by the dried function liquid that has been left or adhered in the suction pipeline after finishing the suction operation.

According to another aspect of the present invention, there is provided an apparatus for sucking a function liquid droplet ejection head in which a cap is brought into close contact with the function liquid droplet ejection head which ejects a function liquid, the suction being made through the cap. The apparatus comprises an ejector which sucks all nozzles of the function liquid droplet ejection head in a state of being in fluid-flow communication with the cap, and working fluid supply means for supplying the ejector with a working fluid.

According to this arrangement, the suction is performed through the cap by using the ejector. Thus, there is less influence of bubbles discharged from a passage inside the head, and the suction of all nozzles of the function liquid droplet ejection head can be stably performed. Moreover, the ejector is small in size because the ejector has no movable parts. Thus, a space can be saved compared to a constitution where a pump is used for the suction.

In this case, it is preferable that the ejector is disposed near the cap.

According to this arrangement, since the ejector is disposed near the cap, a shortest possible(suction) pipeline from the cap to the ejector can be used, and the suction of the function liquid droplet ejection head can be performed efficiently by using the ejector via the cap adhered to the function liquid droplet ejection head.

preferably, the apparatus further comprises: pressure detection means for detecting a pressure in a suction pipeline connecting the cap to a suction port of the ejector; a flow rate regulating valve for regulating a flow rate of the working fluid supplied to the ejector, the valve being interposed in a working fluid supply pipeline connecting the working fluid supply means to a supply port of the ejector; and first control means for controlling the flow rate regulating valve based on a detection result obtained by the pressure detection means.

According to this arrangement, the flow rate of the working fluid supplied to the ejector is regulated by the first control means based on the detection result obtained by the pressure detection means. Thus, a suction pressure to the function liquid droplet ejection head can be properly maintained, and the suction of all the nozzles of the function liquid droplet ejection head can be stably and properly performed.

In this case, it is preferable that the first control means gradually closes the flow rate regulating valve when the suction of the function liquid droplet ejection head is finished.

According to this arrangement, the flow rate regulating valve is gradually closed when the suction for the function liquid droplet ejection head is finished. Thus, there is prevented a possibility that sudden drop in the suction pressure to the function liquid droplet ejection head causes a pressure in the function liquid droplet ejection head to drop below a pressure in the cap adhered to the function liquid droplet ejection head. Moreover, by gradually closing the flow rate regulating valve to control the suction pressure when the suction is finished, a negative pressure in a (suction) pipeline from the function liquid droplet ejection head to the ejector can be gradually lowered. Thus, when the cap is detached from the function liquid droplet ejection head in finishing the suction, the air does not flow back into the function liquid droplet ejection head.

Preferably, the apparatus further comprises a suction pipeline gate valve which is interposed in the suction pipeline and which opens/closes the suction pipeline, and the first control means closes the flow rate regulating valve and the suction pipeline gate valve when the suction of the function liquid droplet ejection head is finished.

According to this arrangement, the flow rate regulating valve is closed when the suction for the function liquid droplet ejection head is finished. Thus, no working fluid is supplied to the ejector, and thereby the suction operation can be stopped. Moreover, by closing the suction pipeline gate valve together with the flow rate regulating valve, the suction for the function liquid droplet ejection head can be surely stopped. Thus, the suction of the function liquid from the function liquid droplet ejection head is not wastefully continued.

Preferably, the suction pipeline gate valve is made of a three-way valve having an atmosphere releasing port, and the first control means opens the atmosphere releasing port (i.e., a port to release,to atmospheric pressure) simultaneously with closing of the suction pipeline gate valve and opens the flow rate regulating valve again.

According to this arrangement, the suction pipeline is released to atmosphere when the suction operation for the function liquid droplet ejection head is finished. Thus, the function liquid filled in the suction pipeline by the suction operation can be discharged via the ejector. Specifically, the suction pipeline is not clogged with the function liquid thickened therein due to drying and the like. Moreover, by opening the flow rate regulating valve again together with the opening of the atmosphere releasing port, the function liquid in the suction pipeline can be immediately discharged. Furthermore, when the working fluid is a liquid, it is possible to prevent the working fluid from staying in the working fluid supply pipeline.

Preferably, the apparatus further comprises a storage tank which stores a function liquid in advance and is connected to a discharge port of the ejector by a discharge pipeline, and the working fluid supply means is made up of a pump and is connected to the storage tank through a circulating pipeline to supply the function liquid as a working fluid.

According to this arrangement, the incompressible function liquid is supplied as the working fluid of the ejector. Thus, the suction can be efficiently performed. Moreover, unlike the case of using compressed air as the working fluid, it is possible to easily recycle the function liquid sucked from (all the nozzles of) the function liquid droplet ejection head without mixing air therewith. Moreover, since the function liquid serving as the working fluid is circulated, an amount of the function liquid used as the working fluid can be suppressed to the minimum, and a space for storing the function liquid as the working fluid can be reduced.

Preferably, a circulating pipeline gate valve made up of a three-way valve having an atmosphere releasing port is interposed in the circulating pipeline connecting the working fluid supply means to the storage tank, and the suction apparatus further comprises second control means for closing the circulating pipeline gate valve and opening the atmosphere releasing port of the circulating pipeline gate valve when suction of the function liquid droplet ejection head is finished.

According to this arrangement, the supply of the function liquid to the working fluid supply means from the storage tank is stopped by closing the circulating pipeline gate valve when the suction for the function liquid droplet ejection head is finished. Thus, the suction for the function liquid droplet ejection head can be stopped. Moreover, by opening the atmosphere releasing port of the circulating pipeline gate valve, the air is released in the circulating pipeline, and thus the function liquid in the circulating pipeline can be discharged to the storage tank.

Preferably, a plurality of function liquid droplet ejection heads are provided, and a plurality of caps, ejectors and suction pipelines are provided, respectively, in accordance with the plurality of function liquid droplet ejection heads.

According to this arrangement, the plurality of caps, ejectors and suction pipelines are provided for the plurality of function liquid droplet ejection heads provided. Thus, it is possible to regulate supply amounts of the working fluid supplied to the respective ejectors for each of the function liquid droplet ejection heads corresponding to the ejectors. In addition, suction of the respective function liquid droplet ejection heads can be performed separately from each other in a proper state. Specifically, according to the present invention, the suction of the respective function liquid droplet ejection heads can be efficiently performed without causing variations in the suction pressure for each of the function liquid droplet ejection heads due to differences in passage resistance and the like such as a case of sucking a plurality of function liquid droplet ejection heads by using one pump. Therefore, a flow rate of the function liquid during suction is not lowered, and the bubbles can be efficiently discharged from the passage. Thus, the function liquid consumed for discharging the bubbles can be reduced. Moreover, a suction time can be made equal among the respective function liquid droplet ejection heads, and thus the suction time for the function liquid droplet ejection heads can be shortened. At the same time, the function liquid consumed during the suction can be reduced.

Preferably, the liquid droplet ejection apparatus comprises the suction apparatus for a function liquid droplet ejection head as described above, and function liquid droplet ejection heads ejecting a function liquid onto a workpiece.

According to this arrangement, the suction of the function liquid droplet ejection heads can be efficiently and properly performed by using the ejector. Thus, time required for performing the suction of the function liquid droplet ejection heads, such as time required for initial filling of the function liquid into the function liquid droplet ejection heads and for cleaning of the function liquid droplet ejection heads, can be shortened. At the same time, the function liquid consumed in the suction can be reduced.

According to another aspect of the present invention, there is provided a method of manufacturing an electrooptic device, wherein a film formation part is formed on a workpiece by a function liquid, using the above-described liquid droplet ejection apparatus.

Further, the electrooptic device according to the present invention is characterized in that a film formation part is formed on a workpiece by a function liquid by using the above-described liquid droplet ejection apparatus.

According to this arrangement, the electrooptic device is manufactured by using a liquid droplet ejection apparatus which is capable of efficiently performing the suction of the function liquid. Thus the electrooptic device can be manufactured efficiently. As the electrooptic device, a liquid crystal display, an organic electro-luminescence (EL) device, an electron-emitting device, a plasma display panel (PDP) device, an electrophoretic display and the like are conceivable. The electron-emitting device conceptually includes so-called field emission display (FED) and surface-conduction electron-emitter display (SED) devices. Furthermore, as the electrooptic device, conceivable are devices that include formation of a metallic wiring, a lens, a resist, a light diffusion body and the like.

The electronic equipment according to the present invention is characterized in that the above-described electrooptic device is mounted thereon.

In this case, as the electronic equipment, a portable telephone equipped with a so-called flat panel display, a personal computer and various other electrical appliances are applicable.

### BRIEF DESCRIPTION OF THE DRAWINGS

The above and other features of the present invention will become readily apparent by reference to the following detailed description when considered in conjunction with the accompanying drawings wherein:

FIG. 1 is an external perspective view of a function liquid ejection apparatus according to an embodiment of the present invention;

FIG. 2 is a right side view thereof;

FIG. 3 is a plan view of a head unit;

FIG. 4A is an external perspective view of a function liquid droplet ejection head, and FIG. 4B is a cross-sectional view thereof when mounted on a piping adaptor;

FIG. 5 is an external perspective view of a suction unit;

FIG. 6 is a cross-sectional view around a cap of the suction unit;

FIGS. 7A and 7B are views explaining a wiping unit: FIG. 7A is a schematic view of the wiping unit; and FIG. 7B is an explanatory view of a wiping operation;

FIG. 8 is a schematic view showing the function liquid droplet ejection head according to the first embodiment of the present invention and a function liquid supply system, air supply means and the suction unit, which are connected to the function liquid droplet ejection head;

FIG. 9 is a schematic diagram around a function liquid pump and a suction unit according to a second embodiment of the present invention;

FIG. 10 is a flowchart explaining steps of manufacturing a color filter;

FIGS. 11A to 11E are schematic cross-sectional views of the color filter in order of the manufacturing steps;

FIG. 12 is a cross-sectional view of a main part, showing a schematic constitution of a liquid crystal device using a color filter to which the present invention is applied;

FIG. 13 is a cross-sectional view of a main part, showing a schematic constitution of a liquid crystal device of a second example using the color filter to which the present invention is applied;

FIG. 14 is an exploded perspective view showing a schematic constitution of a main part of a liquid crystal device of a third example using the color filter to which the present invention is applied;

FIG. 15 is a cross-sectional view of a main part of a display apparatus that is an organic EL device;

FIG. 16 is a flowchart explaining steps of manufacturing the display device that is the organic EL device;

FIG. 17 is a view explaining a step of forming an inorganic bank layer;

FIG. 18 is a view explaining a step of forming an organic bank layer;

FIG. 19 is a view explaining a process of forming a hole injection/transport layer;

FIG. 20 is a view explaining a state where the hole injection/transport layer is formed;

FIG. 21 is a view explaining a process of forming a blue emitting layer;

FIG. 22 is a view explaining a state where the blue emitting layer is formed;

FIG. 23 is a view explaining a state where emitting layers of every color are formed;

FIG. 24 is a view explaining a step of forming a cathode;

FIG. 25 is an exploded perspective view of a main part of a display device that is a plasma display panel (PDP) device;

FIG. 26 is a cross-sectional view of a main part of a display device that is an electron-emitting device (a FED device); and

FIG. 27A is a plan view around an electron-emitting part of the display device, and FIG. 27B is a plan view showing a method of forming the electron-emitting part.

### DETAILED DESCRIPTION OF THE PREFERRED EMBODIMENTS

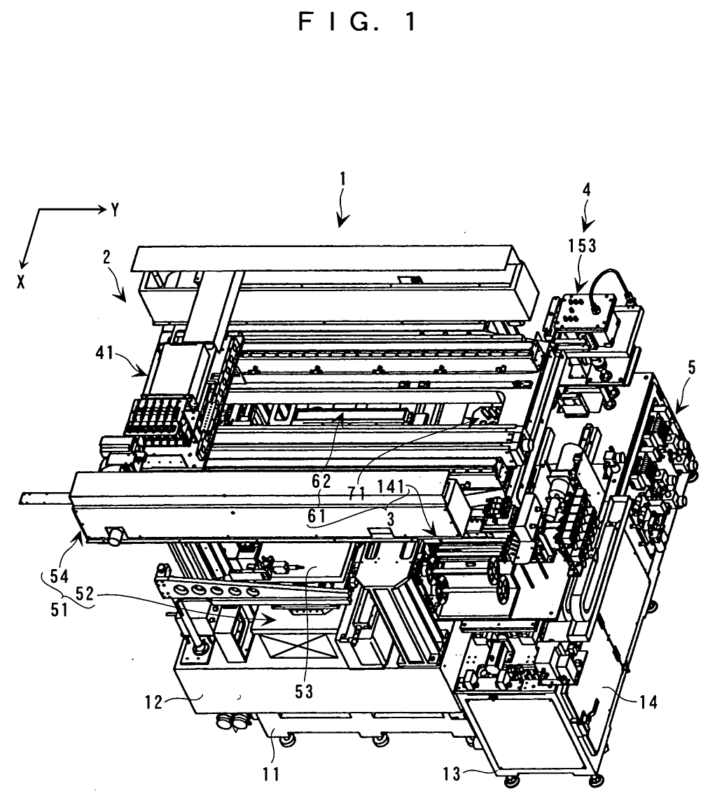

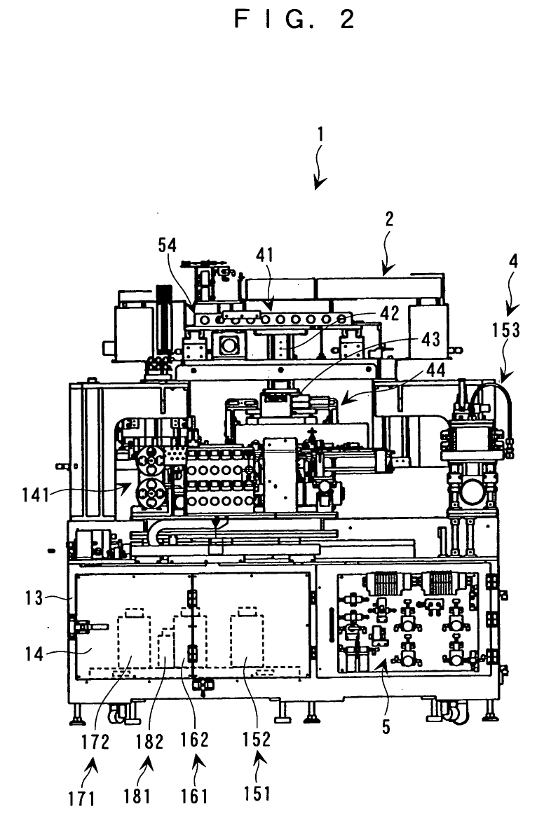

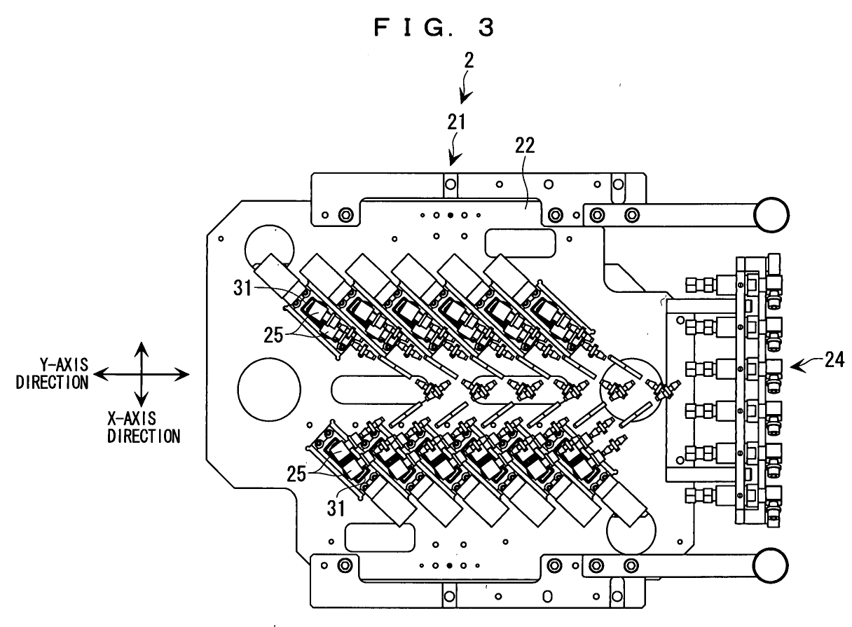

With reference to the accompanying drawings, a first embodiment of the present invention will be described below. FIG. 1 is an external perspective view of a liquid droplet ejection apparatus to which the present invention is applied. FIG. 2 is a right side view of the liquid droplet ejection apparatus to which the present invention is applied. As described later in detail, this liquid droplet ejection apparatus 1 is arranged to form a film formation part of a function liquid on a workpiece W such as a substrate by introducing the function liquid such as a special ink and a luminescent (emitting) resin liquid into a function liquid droplet ejection head 31 (FIG. 3).

As shown in FIGS. 1 and 2, the liquid droplet ejection apparatus 1 includes: ejection means 2 for ejecting the function liquid; maintenance means 3 for performing maintenance of the ejection means 2; liquid supply/recovery means 4 for supplying the respective means with a liquid (for example, the function liquid) and recovering the unnecessary liquid; and air supply means 5 (working fluid supply means) for supplying compressed air for driving and controlling the respective means. A main part of the ejection means 2 is disposed on a stone surface plate 12 provided on a frame 11. Respective main parts of the maintenance means 3, the liquid supply/recovery means 4 and the air supply means 5 are disposed on a common machine table 13 built integrally with the frame 11 and the stone surface plate 12. The respective means described above are controlled by control means 6. The respective means will be described below.

The ejection means 2 includes: a head unit 21 having the function liquid droplet ejection heads 31 which eject the function liquid; a main carriage 41 which supports the head unit 21; and an X/Y moving mechanism 51 which moves the head unit 21 (the function liquid droplet ejection heads 31) relatively to the workpiece W through the main carriage 41.

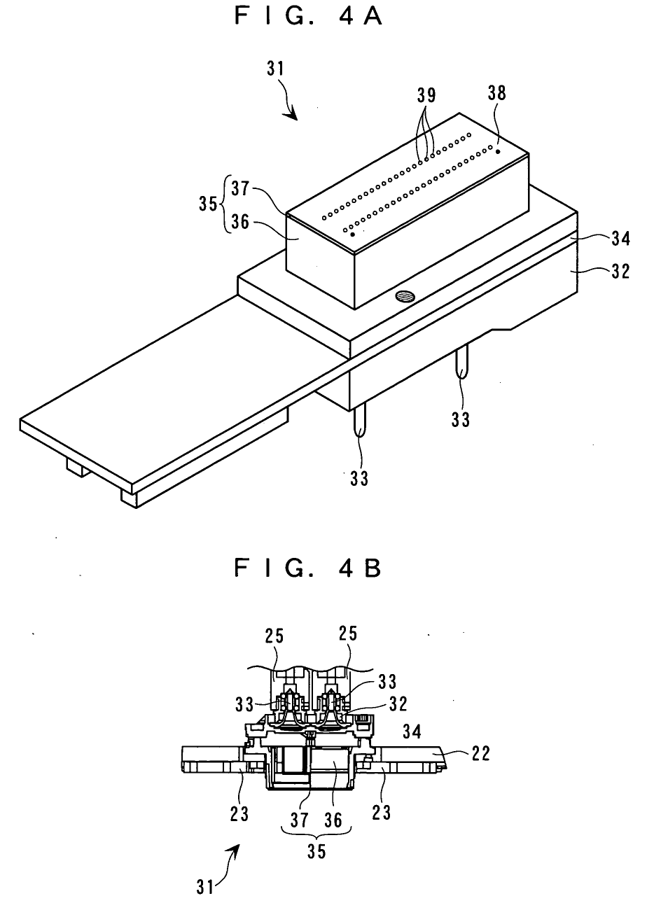

As shown in FIG. 3 and FIGS. 4A and 4B, the head unit 21 includes: twelve of the function liquid droplet ejection heads 31; a sub-carriage 22 carrying the function liquid droplet ejection heads 31 thereon; and a head holding member 23 for attaching the respective function liquid droplet ejection heads 31 to the sub-carriage. 22. On the sub-carriage 22, the twelve function liquid droplet ejection heads 31 are disposed while being divided into two rows so that each row has six of the ejection heads. Moreover, the respective function liquid droplet ejection heads 31 are fixed to the sub-carriage 51 while being tilted at a predetermined angle in order to ensure a sufficient application density of the function liquid to the workpiece W. Furthermore, in the sub-carriage 22, a piping joint 24 is provided to connect the respective function liquid droplet ejection heads 31 to a supply tank 153 (to be described later) through piping. The number and arrangement of the function liquid droplet ejection heads 31 are not limited to those described above but may be arbitrarily decided. For example, the function liquid droplet ejection heads 31 do not have to be tilted when using the function liquid droplet ejection heads 31 exclusively arranged for an intended usage thereof.

As shown in FIGS. 4A and 4B, the function liquid droplet ejection head 31 includes: a so-called twin function liquid introduction part 32 having twin connection needles 33; a twin head substrate 34 connected to the function liquid introduction part 32; and a head main body 35 which is connected to the lower portion of the function liquid introduction part 32 and has an inner passage formed therein, the inner passage being filled with the function liquid. Each of the connection needles 33 is connected to the supply tank 153 to be described later through a piping adaptor 25. Thus, the function liquid introduction part 32 receives a supply of the function liquid from each connection needle 33. The head main body 35 includes a twin pump part 36 and a nozzle forming plate 37 having a large number of ejection nozzles 39 formed therein. In the function liquid droplet ejection head 31, the function liquid is ejected from the ejection nozzles 39 by an action of the pump part 36. A lower surface of the nozzle forming plate 37 is a nozzle forming surface 38 (a nozzle surface), and the function liquid droplet ejection head 31 is fixed to the sub-carriage 22 through the head holding member 23 so as to allow the nozzle forming surface 38 to protrude downward (see FIGS. 4A and 4B).

As shown in FIG. 2, the main carriage 41 includes: a hanging member 42 having an I-shaped appearance, which is fixed to the bottom by a Y-axis table 54 to be described later; a Θ table 43 attached to a lower surface of the hanging member 42 for performing positional correction (of the head unit 21) in the Θ direction; and a carriage main body 44 attached to the Θ table 43 so as to be hung therebelow. The carriage main body 44 has a rectangular aperture for loosely fitting the head unit 21 and positions and fixes the head unit 21. In the carriage main body 44, a workpiece recognition camera (not illustrated) for recognizing the workpiece W is disposed.

The X/Y moving mechanism 51 includes: a suction table 53 which sucks (fixes by suction) the workpiece W; an X-axis table 52 which moves the workpiece W in the. X-axis direction (the main-scanning direction) via the suction table 53; and the Y-axis table 54 which moves the head unit 21 in the Y-axis direction (the sub-scanning direction) via the main carriage 41. The X/Y moving mechanism 51 is disposed on the stone surface plate 12 described above and thus the level of the workpiece W can be maintained and the head unit 21 can be moved with accuracy.

Here, a series of operations of the ejection means 2 will be briefly described. First, as a preparation prior to ejection of the function liquid, a position of the head unit 21 and a position of the set workpiece W are corrected. Next, the X/Y moving mechanism 51 (the X-axis table 52) moves the workpiece W back and forth in the main scanning (the X-axis) direction. In synchronization with the back-and-forth movement of the workpiece W, the plurality of function liquid droplet ejection heads 31 are driven, and a selective ejection operation of the function liquid toward the workpiece W is performed. When the workpiece W is moved back and forth once, the X/Y moving mechanism 51 (the Y-axis table 54) moves the head unit 21 in the sub-scanning (the Y-axis) direction. Thereafter, the back-and-forth movement of the workpiece W in the main scanning direction and the drive of the function liquid droplet ejection heads 31 are performed again. In this embodiment, the workpiece W is moved in the main scanning direction with respect to the head unit 21. However, the head unit 21 may be moved in the main scanning direction. Moreover, the workpiece W may be moved in the main-scanning and sub-scanning directions while fixing the head unit 21.

Next, the maintenance means 3 will be described. The maintenance means 3 maintains the function liquid droplet ejection heads 31 so that the ejection heads properly eject the function liquid. The maintenance means 3 includes a flushing unit 61, a suction unit 71 and a wiping unit 141 (see FIG. 1).

The flushing unit 61 receives the function liquid sequentially ejected by a flushing operation of the plurality of (twelve) function liquid droplet ejection heads 31 during the liquid droplet ejection, that is, a preliminary ejection (wasteful ejection) from all the ejection nozzles 39. The flushing unit 61 is fixed to the X-axis table 52 and a pair of flushing boxes 62 receiving the ejected function liquid are fixed while sandwiching the suction table 53 therebetween. The flushing boxes 62 move toward the head unit 21 together with the workpiece W in accordance with the main scanning, and thus the flushing operations can be sequentially performed from the ejection nozzles 39 of the function liquid droplet ejection heads 31 facing the flushing boxes 62. Thereafter, the function liquid received by the flushing boxes 62 is stored in a waste tank 182 to be described later. In the flushing operation of this embodiment, the preliminary ejection is performed from all the ejection nozzles 39. However, the preliminary ejection may be performed only from a part of the ejection nozzles, for example, only from the ejection nozzles 39 to be used.

The suction unit 71 is provided on the common machine stand 13 described above and is for performing suction of the function liquid droplet ejection heads 31. Specifically, the suction unit 71 is used in the case of filling the head unit 21 with the function liquid, such as in the case of newly providing the head unit 21 with the function liquid droplet ejection head 31, and in the case of performing suction (cleaning) for removing the function liquid thickened in the function liquid droplet ejection heads 31.

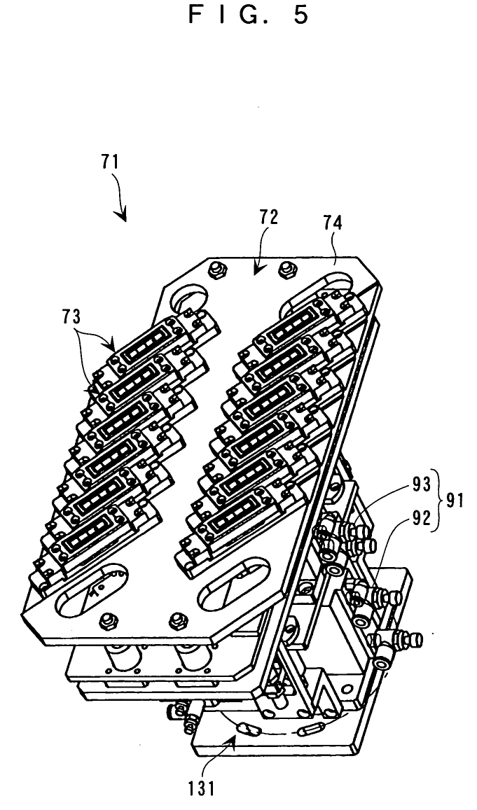

As shown in FIG. 5, the suction unit 71 includes: a cap unit 72 having twelve caps 73 which adhere to the respective function liquid droplet ejection heads 31; a lift mechanism 91 which allows the caps 73 to separate from and contact the function liquid droplet ejection heads 31 by lifting up and down the cap unit 72; ejectors 101 for sucking the function liquid through the adhered caps 73; a suction tube (system) 111 for connecting the respective caps 73 to the ejectors 101; and a supporting member 131 for supporting the cap unit 72.

As shown in FIG. 5, in the cap unit 72, the twelve caps 73 are disposed on a cap base 74 corresponding to the positions of the twelve function liquid droplet ejection heads 31 mounted on the head unit 21. The respective caps 73 can be adhered to (or brought into close contact with) the corresponding function liquid droplet ejection heads 31.

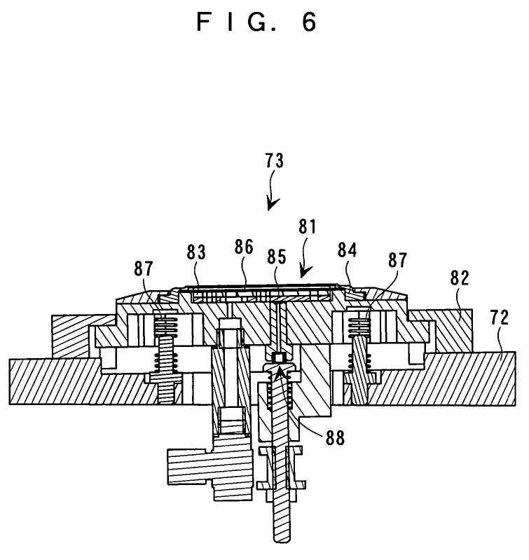

As shown in FIG. 6, each of the caps 73 includes a cap main body 81 and a cap holder 82. The cap main body 81 is urged upward by two springs 87 and held by the cap holder 82 so as to be able to move slightly in a vertical direction. In an upper surface of the cap main body 81, a concave part 83 is formed, which includes each of the two arrays of ejection nozzles 39 of the function liquid droplet ejection head 31. In a peripheral portion of the concave part 83, a seal packing 84 is fitted. An absorber 85 is laid on a bottom of the concave part 83 while being pressed by a pressing frame 86. During the suction of the function liquid droplet ejection head 31, the seal packing 84 is pressed against the nozzle forming surface 38 of the function liquid droplet ejection head 31 and is adhered thereto. Thus, the nozzle forming surface 38 is sealed so as to include the two arrays of ejection nozzles 39 therein. An air open valve (relief valve) 88 is provided in each of the caps 73 so as to open to atmosphere at the bottom side of the concave part 83 (see FIG. 6). At the final stage of the suction operation, the relief valve 88 is opened to atmosphere air and thus the function liquid contained in the absorber 85 can also be sucked.

The lift mechanism 91 is formed of air cylinders and includes two lift cylinders 92 and 93 having different strokes from each other. A selective operation of both the lift cylinders 92 and 93 can freely switch a lifted position of the cap unit 72 between a first position which is relatively high, and a second position which is relatively low. When the cap unit 72 is at the first position, each cap 73 is adhered to each function liquid droplet ejection head 31 and, when the cap unit 72 is at the second position, a narrow gap is formed between the function liquid droplet ejection head 31 and the cap 73.

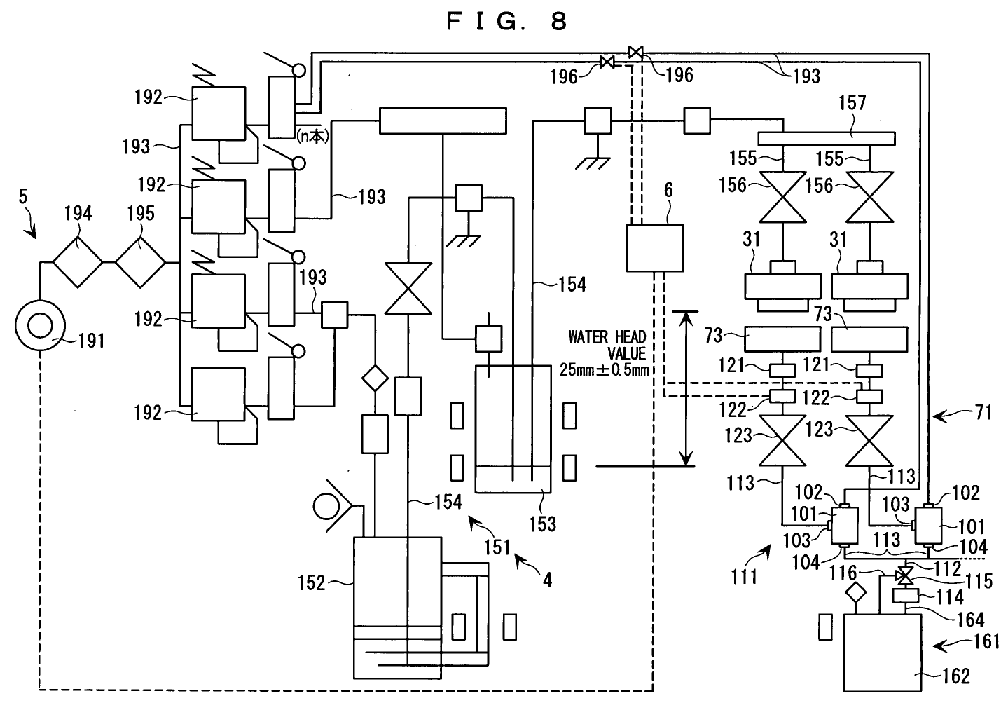

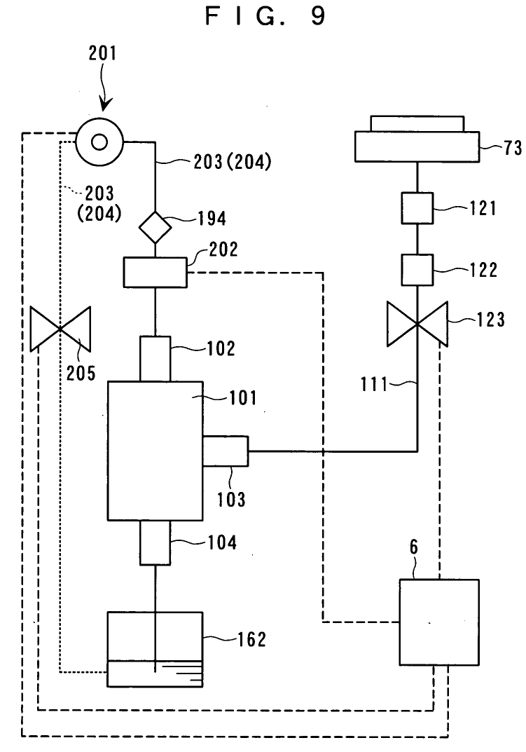

The ejectors 101 are connected to the caps 73 by using the suction tube 111 and perform suction from all the nozzles 39 of the function liquid droplet ejection heads 31 through the caps 73. The ejectors 101 are provided in the vicinity of the caps 73 so as to be able to perform efficient suction of the function liquid droplet ejection heads 31. As shown in FIGS. 8 and 9, one ejector 101 is disposed for each of the caps 73, that is, twelve ejectors 101 are disposed in total. Between the cap 73 and the ejector 101, a function liquid detection sensor 121 for detecting the presence of the function liquid, a cap-side pressure sensor 122 (a pressure detection means) for detecting a pressure in the suction tube 111 and a cap-side gate valve 123 (a suction pipeline gate valve) for opening/closing the suction tube 111 are provided in the described order as seen from the cap 73 side.

The ejector 101 includes: a supply port 102 which is connected to the air supply means 5 described above and receives a supply of the compressed air serving as the working fluid; a suction port 103 which is connected to the cap 73 and operates a suction force; and a discharge port 104 which is continued from the supply port 102 and discharges the supplied working fluid and the bubbles and function liquid sucked from the suction port 103. Specifically, a negative pressure is generated in the ejector 101 by an accompanied flow generated as the compressed air is supplied. Thus, the suction of the function liquid droplet ejection head 31 having the caps 73 adhered thereto can be performed through the suction port 103. Accordingly, a supply amount of the compressed air is regulated by a flow rate regulating valve 196 to be described later. Thus, the suction force (a suction pressure) from the suction port 103 can be regulated. The ejector 101 has no movable parts and is relatively small in size. Thus, by performing the suction of the function liquid droplet ejection head 31 by using the ejector 101, the apparatus can be made smaller than the construction in which the suction is performed by using a pump. Moreover, the bubbles sucked from the suction port 103 prior to the function liquid are immediately discharged from the discharge port 104 together with the compressed air. Thus, unlike the case of performing the suction by using the pump, the suction force is not lowered by air leakage.

The suction tube (system) 111 includes a sucking tube 112 and branched sucking tubes 113 (suction pipelines) which are obtained by dividing the sucking tube 112 into multiple (twelve) branches. By using the branched sucking tubes 113, the caps 73 and the ejectors 101 are connected to each other. In the liquid droplet ejection apparatus 1 of this embodiment, the respective caps 73 also serve as function liquid trays which catch the function liquid ejected by the flushing operations of the function liquid droplet ejection heads 31 during a non-ejection period of the function liquid, that is, when the ejection of the function liquid toward the workpiece W is temporarily stopped. In the sucking tube 112, a suction pump 114 for sucking the function liquid ejected by the flushing through the caps is provided. As shown in FIG. 8, a three-way valve 115 is provided in the sucking tube 112 upstream of the suction pump 114. To the three-way vale 115, a discharge tube 116 is connected, which has one end connected to a recycling tank 162 for guiding the working fluid and function liquid discharged from the ejectors 101 to the recycling tank 162.

Accordingly, by switching the three-way valve 115, it is possible to selectively use the ejectors 101 and the suction pump 114. Specifically, the ejectors 101 are used when filling the function liquid droplet ejection heads 31 with the function liquid or when cleaning the function liquid droplet ejection heads 31. At this time, the three-way valve 115 is switched to bring the sucking tube 112 into fluid-flow communication with the discharge tube 116. On the other hand, when the suction pump 114 is used such as in the case of sucking the function liquid ejected by flushing, the three-way valve 115 is switched to bring the sucking tube 112 into fluid-flow communication with the suction pump 114.

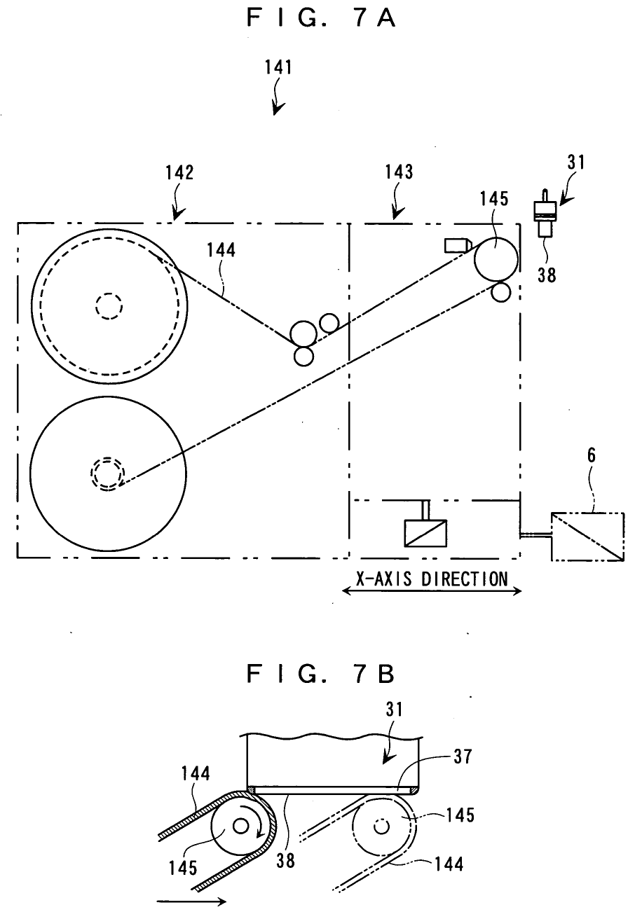

The wiping unit 141 is provided on the common machine table 13 similarly to the suction unit 71 and wipes the nozzle forming surface 38 of the function liquid droplet ejection head 31 contaminated by the function liquid adhered thereto, by performing suction (cleaning) of the function liquid droplet ejection head 31 and the like while moving the nozzle forming surface 38 in the X-axis direction. As shown in FIGS. 7A and 7B, the wiping unit 141 includes: a winding sub-unit 142 for taking out and winding up a wiping sheet for wiping; and a wiping sub-unit 143 having a wiping roller 145 for allowing the wiping sheet 144 to come into contact with the nozzle forming surface 38. In a state of being sufficiently close to the function liquid droplet ejection head 31, the wiping unit 141 takes out the wiping sheet 144 from the winding sub-unit 142 and wipes the blot while pressing the taken-out wiping sheet 144 against the nozzle forming surface 38 of the function liquid droplet ejection head 31 by using the wiping roller 145. The taken-out wiping sheet 144 is supplied with a cleaning fluid from a cleaning fluid supply system 171 to be described later so that the function liquid adhered to the function liquid droplet ejection head 31 can be efficiently wiped off.

Next, the liquid supply/recovery means 4 will be described. The liquid supply/recovery means 4 includes: a function liquid supply system 151 which supplies the function liquid to the respective function liquid droplet ejection heads 31 of the head unit 21; a function liquid recovery system 161 which recovers the function liquid sucked by the suction unit 71 of the maintenance means 3; the cleaning fluid supply system 171 which supplies a solution containing function materials to the wiping unit 141 for cleaning; and a waste liquid recovery system 181 which recovers the function liquid received by the flushing unit 61. As shown in FIG. 2, in a chamber 14 of the common machine table 13, a pressurization tank 152 of the function liquid supply system 151, the recycling tank 162 of the function liquid recovery system 161 and a cleaning fluid tank 172 of the cleaning fluid supply system 171 are horizontally disposed in this order from the right side of the drawing. In addition, in the vicinity of the recycling tank 162 and the cleaning fluid tank 172, a small-sized waste liquid tank 182 of the waste liquid recovery system 181 is provided.

The function liquid supply system 151 includes: the pressurization tank 152 which stores a large amount (3 liters) of the function liquid; a supply tank 153 which stores the function liquid sent from the pressurization tank 152 and supplies the function liquid to the respective function liquid droplet ejection heads 31; and a supply tube 154 which forms supply lines and connects these supply lines by piping (see FIGS. 1, 2 and 8). The function liquid stored in the pressurization tank 152 is pumped to the supply tank 153 through the supply tube 154 by using compressed air (inert gas) introduced from the air supply means 5 to be described later.

In the supply tank 153, a pressure from the pressurization tank 152 is cut off by releasing to the atmosphere. Consequently, a water head pressure in the supply tank 153 is maintained to be slightly negative (for example, 25 mm±0.5 mm) compared to the function liquid droplet ejection head 31. Thus, dripping of the function liquid from the function liquid droplet ejection heads 31 is prevented. At the same time, the liquid droplets are ejected at high accuracy by a pumping action of the function liquid droplet ejection heads 31, that is, a pump drive of a piezoelectric element in the pump part 36.

To the supply tank 153, six supply tubes 154 extending to the function liquid droplet ejection heads 31 are connected. Each of the supply tubes 154 is biforked via a T-joint 157 and thus twelve branched supply tubes 155 are formed in total. The twelve branched supply tubes 155 are connected to piping joints 24 provided in the head unit 21 as apparatus side piping members and supply the respective function liquid droplet ejection heads 31 with the function liquid (see FIGS. 1 and 8). Moreover, in each of the branched supply tubes 155, a head side supply valve 156 for opening/closing the branched supply tube 155 is provided. Opening/closing by the head side supply valve 156 is controlled by the control means 6.

The function liquid recovery system 161 is for storing the function liquid sucked by the ejectors 101 of the suction unit 71 and by the suction pump 114 and includes: the recycling tank 162 which stores the sucked function liquid; and a recovery tube 164 which is connected to the suction pump 114 and guides the sucked function liquid to the recycling tank 162.

The cleaning fluid supply system 171 is for supplying the cleaning fluid to the wiping sheet 144 of the wiping unit 141 and includes: the cleaning fluid tank 172 which stores the cleaning fluid; and a cleaning fluid supply tube (not illustrated) for supplying the cleaning fluid in the cleaning fluid tank 172. The cleaning fluid is supplied by introducing compressed air to the cleaning fluid tank 172 from the air supply means 5. Moreover, a function liquid solution with relatively high volatility is used as the cleaning fluid, and thus the function liquid adhered to the function liquid droplet ejection heads 31 can be efficiently wiped off.

The waste liquid recovery system 181 is for recovering the function liquid ejected to the flushing unit 61 and includes: the waste liquid tank 182 which stores the recovered function liquid; a waste liquid pump (not illustrated) which is connected to the flushing unit 61 (the flushing boxes 62) and guides the function liquid ejected to the flushing boxes 62 to the waste liquid tank 182; and a waste liquid tube (not illustrated) which connects the waste liquid tank 182 to the waste liquid pump by piping.

Next, the air supply means 5 will be described. As shown in FIG. 8, the air supply means 5 supplies compressed air obtained by compressing inert gas (N₂) to the respective parts such as the pressurization tank 152 and the ejectors 101, for example. The air supply means 5 includes: an air pump 191 (a compressor) for compressing the inert gas; a regulator 192 for maintaining a pressure therein at a predetermined constant pressure in accordance with a destination to which the compressed air is supplied; and the air supply tube 193 for supplying the compressed air to the respective parts by connecting the air pump 191 to the respective parts by piping. In the air supply tube 193 connecting the air pump 191 and the regulator 192, an air (liquid) filter 194 for removing foreign particles in the compressed air (the function liquid) and a separator 195 for removing the oil content are provided. Moreover, in the air supply tube 193 (a working fluid supply pipeline) connecting the air pump 191 and the ejectors 101, the flow rate regulating valve 196 (a flow rate controlling valve) for adjusting a supply amount of the compressed air. Thus, the supply amount of the compressed air supplied to the respective ejectors 101 can be controlled.

Next, the control means 6 will be described. The control means 6 includes a control unit for controlling operations of the respective means. The control unit stores control programs and control data therein and has a work area for performing various control processing. The control means 6 is connected to the aforementioned respective means and controls the entire apparatus.

With reference to FIG. 8, description will be given regarding a case of performing the suction of the function liquid droplet ejection heads 31 by using the suction unit 71, as an example of the control by the control means 6. When performing the suction of the function liquid droplet ejection heads 31, the control means 6 (first control means) drives the foregoing X/Y moving mechanism 51 and first allows the head unit 21 to face the suction unit 71 disposed on the common machine table 13. Thereafter, the lift mechanism 91 of the suction unit 71 is driven to raise the cap unit 72 to the first position, and the respective caps 73 are adhered to the corresponding function liquid droplet ejection heads 31.

Next, the flow rate regulating valve 196 provided in the air supply tube 193 is gradually opened, the compressed air is supplied to the twelve ejectors 101 from the air supply means 5, and the suction of the function liquid droplet ejection heads 31 is started. The supply amount of the compressed air during the suction is controlled appropriately for each of the ejectors 101 by controlling opening/closing of the flow rate regulating valve 196 based on a detection result of the respective cap-side pressure sensors 122 described earlier. Specifically, when the suction pressure in the suction tube 111 (the branched sucking tube 113) drops below a predetermined pressure, the supply amount of the compressed air is increased by controlling the flow rate regulating valve 196. On the other hand, when the suction pressure in the suction tube 111 rises above the predetermined pressure, the supply amount of the compressed air is reduced by controlling the flow rate regulating valve 196. In such a manner, the suction of the respective function liquid droplet ejection heads 31 is controlled to be performed at the constant suction pressure. Thus, by controlling the supply amount of the compressed air separately by using the respective ejectors 101, the suction of the respective function liquid droplet ejection heads 31 can be performed efficiently and properly.

In this embodiment, the ejectors 101 are provided for the respective caps 73 in order to separately control the suction pressure for the respective function liquid droplet ejection heads 31. However, by dividing the branched sucking tube 113 which is connected to the suction port 103 of the ejector 101 into branches, one ejector 101 may be provided for the plurality of caps 73. In other words, it is possible to perform suction of two caps 73 by using one ejector 101 or to perform suction of twelve caps 73 by using one ejector 101. The number of the ejectors 101 can be changed depending on the situation.

When finishing the suction of the function liquid droplet ejection heads 31, first, the flow rate regulating valve 196 is gradually closed. Thus, sudden drop in the suction pressure is prevented, and reverse flow of the bubbles into the function liquid droplet ejection heads 31 after the suction is finished is prevented. Moreover, simultaneously with the closing of the flow rate regulating valve 196, the cap-side gate valve 123 described earlier is controlled to be closed, and the suction operation is surely completed. Thus, wasteful consumption of the expensive function liquid is prevented.

Thereafter, by driving the lift mechanism 91, the cap unit 72 is descended to release the respective caps 73 to the atmosphere, and the flow rate regulating valve 196 is opened again. Thus, the function liquid absorbed in the absorber 85 of the respective caps 73 and the function liquid left in the suction tube 111 can be guided to the recycling tank 162. When the caps 73 are not arranged to be capable of releasing to the atmosphere, it is preferable to form the aforementioned cap-side gate valve 123 by using a three-way valve having an atmosphere releasing port. Subsequently, after closing the flow rate regulating valve 196 and switching the cap-side gate valve 123 to the atmosphere releasing port, the flow rate regulating valve 196 is opened. Thus, clogging caused by the function liquid left in the suction tube 111 is prevented.

Next, a second embodiment of the present invention will be described. A basic constitution of a liquid droplet ejection apparatus 1 according to this embodiment is approximately the same as that of the first embodiment described above. However, the liquid droplet ejection apparatus 1 of the second embodiment is different in that, instead of the compressed air from the air supply means 5, the function liquid is used as the working fluid supplied to the ejectors 101 of the suction unit 71.

With reference to FIG. 9, the supply port 102 of the ejector 101 is connected to the function liquid pump 201, which is formed of a high-pressure pump, through a pressure regulating valve 202. The discharge port 104 is connected to the recycling tank 162 (a storage tank) via connection tubes 203 (discharge pipelines). In this embodiment, the suction force of the ejector 101 is controlled by using the pressure regulating valve 202 to control the pressure of the function liquid sent from the function liquid pump 201. The suction port 103 of the ejector 101 is connected to the cap 73 by using the branched sucking tube 113 similarly to the first embodiment. Thus, suction from the function liquid droplet ejection head 31 is possible through the cap 73.

The recycling tank 162 and the function liquid pump 201 are connected to each other by using the connection tubes 203. A pipeline to the ejector 101 and the recycling tank 162 from the function liquid pump 201 and a pipeline to the function pump 201 from the recycling tank 162 form a circulating pipeline 204 in which the function liquid that is to be the working fluid circulates. In the circulating pipeline 204 connecting the recycling tank 162 and the function liquid pump 201, a gate valve 205 (a circulating pipeline gate valve) formed of a three-way valve having an atmosphere releasing port is provided. Moreover, in the recycling tank 162, a sufficient amount of function liquid to fill the circulating pipeline 204 is stored in advance. Thus, continuous supply of the function liquid as the working fluid to the ejector 101 enables stable suction.

Here, with reference to FIG. 9, a series of suction operations and control of the function liquid droplet ejection head 31 will be described. First, similarly to the case of the first embodiment, the control means 6 (second control means) allows the cap 73 to adhere to the function liquid droplet ejection head 31 after allowing the head unit 21 to face the suction unit 71. Next, drive of the function liquid pump 201 is started, the function liquid as the working fluid of the ejector 101 is pumped out of the recycling tank 162, and the function liquid is sent to the pressure regulating valve 202.

The pressure regulating valve 202 is controlled by the control means 6 based on a detection result of each cap-side pressure sensor 122 so as to maintain an appropriate suction pressure for each cap 73. Specifically, when the suction pressure in the branched sucking tube 113 drops below a predetermined pressure, an amount of the function liquid to be sent is increased. On the other hand, when the suction pressure in the branched sucking tube 113 rises above the predetermined pressure, the amount of the function liquid to be sent is reduced.

The function liquid that has passed through the pressure regulating valve 202 is sent to the supply port 102 of the ejector 101 by an appropriate pressure and is discharged from the discharge port 104 to the recycling tank 162 while generating a suction force. Moreover, the function liquid sucked from the function liquid droplet ejection head 31 also joins the function liquid supplied from the supply port 102 in the ejector 101 and is discharged from the discharge port 104 to the recycling tank 162. Thereafter, the function liquid discharged to the recycling tank 162 is pumped out again by the function liquid pump 201 and continues to circulate as the working fluid.

As described above, in this embodiment, the incompressible function liquid is used as the working fluid. Thus, further efficient suction of the function liquid droplet ejection head 31 is possible. Moreover, the circulation of the function liquid makes it possible to minimize the amount of the function liquid used for the suction of function liquid droplet ejection head 31. In addition, the recycling tank is miniaturized to enable saving of a space in the apparatus. Furthermore, unlike the case of using the compressed air as the working fluid, no bubbles (compressed air) are mixed in discharging the sucked function liquid. Thus, the discharged function liquid can be easily recycled.

When finishing the suction operation for the function liquid droplet ejection head 31, in order to prevent sudden drop in the suction pressure, the control means 6 controls the pressure regulating valve 202 to gradually lower the pressure of the function liquid supplied to the ejector 101 and reduce the amount of the function liquid sent by the function liquid pump 201. Thereafter, the forgoing gate valve 205 is closed to stop the supply of the function liquid from the recycling tank 162. Subsequently, the gate valve 205 is switched to the atmosphere releasing port to release the air in the circulating pipeline, and thereby the function liquid left in the circulating pipeline is sent into the recycling tank 162. The drive of the function liquid pump 201 is then stopped and the suction operation is finished.

As described above, in the liquid droplet ejection apparatus 1 according to the first and second embodiments, the suction of the function liquid droplet ejection head 31 is performed by using the ejector. Thus, unlike the case of performing the suction by using the pump, the suction force is not lowered by the influence of the bubbles sucked prior to the function liquid, and the suction of the function liquid droplet ejection head 31 can be efficiently performed. Therefore, application of the foregoing liquid droplet ejection apparatus 1 to manufacturing of various products enables efficient manufacturing thereof.

Next, the color filter, the liquid crystal display, the organic EL device, the plasma display (PDP device), the electron-emitting device (FED device and SED device) and the like will be taken as examples of the electrooptic device (flat panel display) manufactured by using the liquid droplet ejection device 1 according to this embodiment, and structures and manufacturing methods thereof will be described.

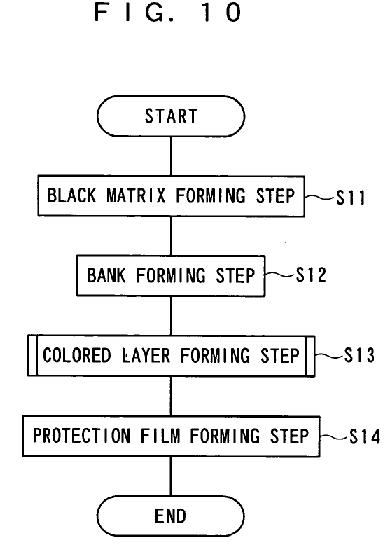

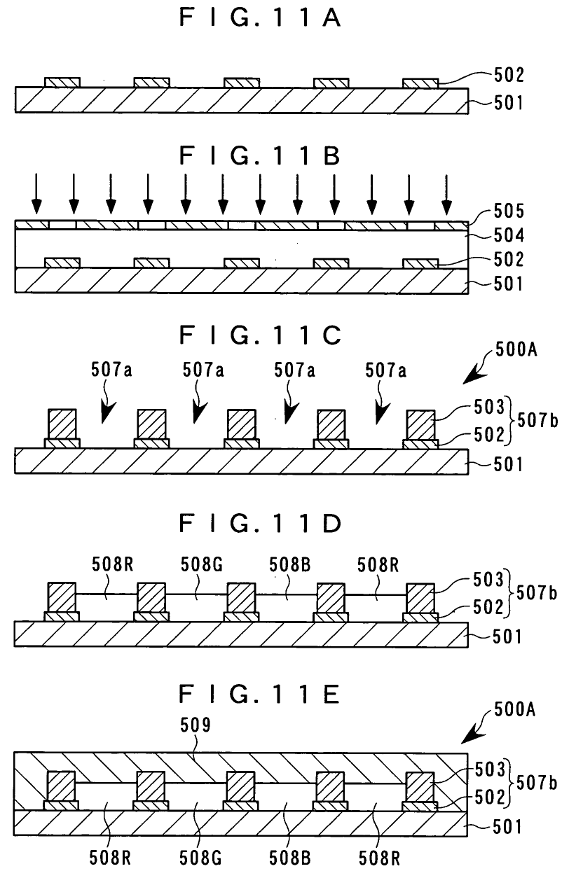

First, a method of manufacturing a color filter installed in the liquid crystal display, the organic EL device or the like will be described. FIG. 10 is a flowchart showing steps of manufacturing the color filter. FIGS. 11A to 11E are schematic cross-sectional views showing a color filter 500 (a filter substrate 500A) of the embodiment in the order of the manufacturing steps.

First, as shown in FIG. 11A, in a black matrix formation step (S11), a black matrix 502 is formed on a substrate (W) 501. The black matrix 502 is formed by chromium metal, a lamination body of and chromium oxide, resin black or the like. For the formation of the black matrix 502 made of a metal thin film, a sputtering method, a deposition method or the like can be used. Moreover, in the case of forming the black matrix 502 made of a resin thin film, a gravure printing method, a photoresist method, a thermal transfer method or the like can be used.

Subsequently, in a bank formation step (S12), a bank 503 is formed in a state of being superposed on the black matrix 502. Specifically, as shown in FIG. 11B, a resist layer 504 made of transparent negative-type photosensitive resin is first formed so as to cover the substrate 501 and the black matrix 502. Thereafter, an upper surface of the resist layer is coated with a mask film 505 formed to have a matrix pattern and exposure processing is performed in this state.

Furthermore, as shown in FIG. 11C, an unexposed portion of the resist layer 504 is patterned by etching, and thus the bank 503 is formed. In the case of forming the black matrix by the resin black, it is possible to use the black matrix and the bank in combination.

This bank 503 and the black matrix 502 therebelow become partition walls 507b which separate respective pixel regions 507a from each other. The partition walls 507b define shot areas of the function liquid in forming colored layers (film formation parts) 508R, 508G and 508B by using the liquid droplet ejection heads 31 in a colored layer formation step at a later stage.

Through the black matrix formation step and the bank formation step described above, the foregoing filter substrate 500A is obtained.

In the embodiment, used as a material of the bank 503 is a resin material that makes a coated film surface thereof lyophobic (hydrophobic). Since a surface of the substrate (glass substrate) 501 is lyophilic (hydrophilic), accuracy of shot positions of liquid droplets into the respective pixel regions 507a surrounded by the bank 503 (the partition wall parts 507b) is improved in the colored layer formation step to be described later.

Next, in the colored layer formation step (S13), as shown in FIG. 11D, the function liquid is ejected by the function liquid droplet ejection heads 31 into the respective pixel regions 507a surrounded by the partition walls 507b. In this case, the function liquid is ejected by using the function liquid droplet ejection heads 31 and introducing function liquids (filter materials) of three colors of R, G and B. An arrangement pattern of the three colors of R, G and B includes a stripe arrangement, a mosaic arrangement, a delta arrangement and the like.

Thereafter, the function liquids are fixed through drying treatment (processing such as heating), and the colored layers 508R, 508G and 508B of the three colors are formed. When the colored layers 508R, 508G and 508B are formed, the processing moves to a protection film formation step (S14). As shown in FIG. 11E, a protection film 509 is formed so as to cover upper surfaces of the substrate 501, the partition walls 507b and the colored layers 508R, 508G and 508B.

Specifically, after a coating agent for the protection film is ejected to the entire surface of the substrate 501 on which the colored layers 508R, 508G and 508B are formed, the protection film 509 is formed through the drying treatment.

Subsequently, after forming the protection film 509, the substrate 501 is cut into individual effective pixel regions, and thus the color filter 500 is obtained.

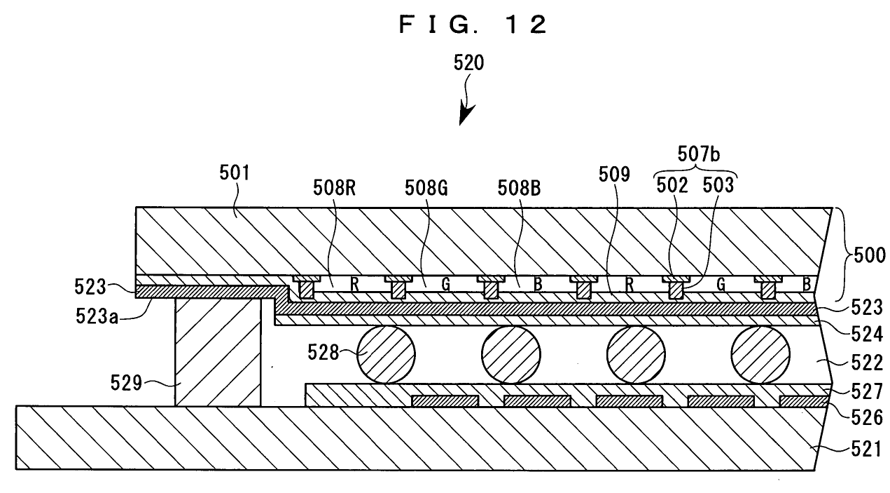

FIG. 12 is a cross-sectional view of a main part, showing a schematic constitution of a passive matrix liquid crystal device (liquid crystal device) as an example of a liquid crystal display using the above-described color filter 500. By mounting accessory elements such as an IC for driving liquid crystal, a backlight and a support on this liquid crystal device 520, a transparent liquid crystal display is obtained as a final product. The color filter 500 is the same as that shown in FIG. 11 and thus the corresponding parts are denoted by the same reference numerals, and description thereof will be omitted.

This liquid crystal device 520 is schematically constituted by using the color filter 500, a counter substrate 521 made of a glass substrate or the like and a liquid crystal layer 522 which is made of a super twisted nematic (STN) liquid crystal composition and is sandwiched between the color filter 500 and the counter substrate 521. The color filter 500 is disposed at the upper side in the drawing (an observer side).

Though not illustrated, polarizers are disposed on outer surfaces (surfaces opposite to the liquid crystal layer 522 side) of the counter substrate 521 and the color filter 500, respectively. Moreover, a backlight is provided outside of the polarizer positioned at the counter substrate 521 side.

On the protection film 509 of the color filter 500 (the liquid crystal layer side), a plurality of strip-shaped first electrodes 523 are formed at predetermined intervals. The first electrodes 523 are long in the right-and-left direction in FIG. 12. A first alignment layer 524 is formed so as to cover surfaces of these first electrodes 523, which is opposite to the color filter 500 side.

Meanwhile, on a surface of the counter substrate 521, which faces the color filter 500, a plurality of strip-shaped second electrodes 526 are formed at predetermined intervals. The second electrodes 526 are long in a direction orthogonal to the first electrodes 523 of the color filter 500. A second alignment layer 527 is formed so as to cover surfaces of these second electrodes 526 at the liquid crystal layer 522 side. These first and second electrodes 523 and 526 are formed by using a transparent conductive material such as ITO (indium tin oxide).

Spacers 528 provided in the liquid crystal layer 522 are members for maintaining a constant thickness (cell gap) of the liquid crystal layer 522. Moreover, a seal 529 is a member for preventing the liquid crystal composition in the liquid crystal layer 522 from leaking to the outside. One end of each of the first electrodes 523 is extended as a tie-in wire 523a to the outside of the seal 529.

Portions where the first and second electrodes 523 and 526 intersect with each other are pixels. The colored layers 508R, 508G and 508B of the color filter 500 are positioned in these portions to form the pixels.

In usual manufacturing steps, the portions at the color filter 500 side are prepared by patterning of the first electrodes 523 and coating with the first alignment layer 524 onto the color filter 500. At the same time, the portions at the counter substrate 521 side are prepared by patterning of the second electrodes 526 and coating of with the second alignment layer 527 onto the counter substrate 521 to the. Thereafter, the spacers 528 and the seal 529 are formed at the counter substrate 521 side and the parts at the color filter 500 side are attached thereto in this state. Subsequently, liquid crystal included in the liquid crystal layer 522 is injected from an inlet of the seal 529 and the inlet is sealed. Thereafter, both the polarizers and the backlight are laminated.

In the liquid droplet ejection apparatus 1 according to the embodiment, before applying a spacer material (a function liquid) included in the above-described cell gap and attaching the portions at the color filter 500 side to the portions at the counter substrate 521 side, for example, liquid crystal (a function liquid) can be evenly applied onto a region surrounded by the seal 529. Moreover, the above-described seal 529 can be printed by using the function liquid droplet ejection heads 31. Furthermore, the first and second alignment layers 524 and 527 can also be applied by using the function liquid droplet ejection heads 31.

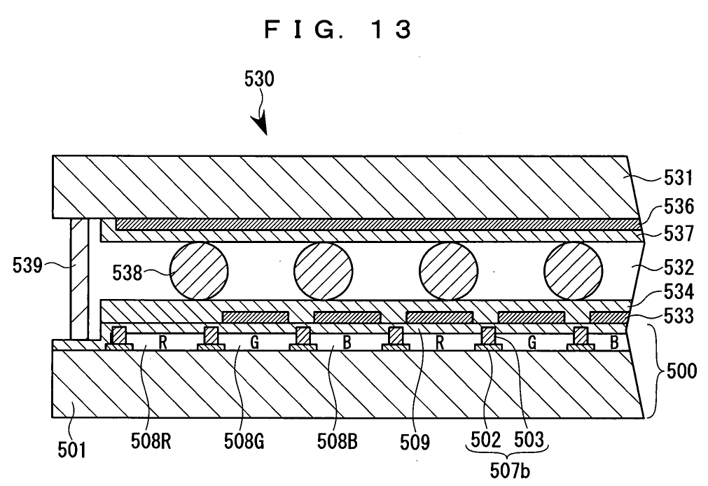

FIG. 13 is a cross-sectional view of a main part, showing a schematic constitution of a liquid crystal display of a second example, which uses the color filter 500 manufactured in this embodiment.

This liquid crystal device 530 is significantly different from the foregoing liquid crystal device 520 in that the color filter 500 is disposed at the lower side in the drawing (opposite to the observer side).

This liquid crystal device 530 is schematically constituted in a manner that a liquid crystal layer 532 made of STN liquid crystal is sandwiched between the color filter 500 and a counter substrate 531 made of a glass substrate or the like. Although not illustrated, polarizers and the like are disposed on outer surfaces of the counter substrate 531 and the color filter 500, respectively.

On the protection film 509 of the color filter 500 (on the liquid crystal layer 532 side), a plurality of strip-shaped first electrodes 533, which are long in a depth direction in the drawing, are formed at predetermined intervals. A first alignment layer 534 is formed so as to cover surfaces of these first electrodes 533 on the liquid crystal layer 532 side.

On a surface of the counter substrate 531, which faces the color filter 500, a plurality of strip-shaped second electrodes 536 are formed at predetermined intervals, extending in a direction orthogonal to the first electrodes 533 on the color filter 500 side. A second alignment layer 537 is formed so as to cover surfaces of these second electrodes 536 on the liquid crystal layer 532 side.

In the liquid crystal layer 532, provided are: spacers 538 for maintaining a constant thickness of this liquid crystal layer 532; and a seal 539 for preventing a liquid crystal composition in the liquid crystal layer 532 from leaking to the outside.

Similarly to the foregoing liquid crystal device 520, portions where the first and second electrodes 533 and 536 intersect with each other are pixels. The colored layers 508R, 508G and 508B of the color filter 500 are positioned in these portions to form the pixels.

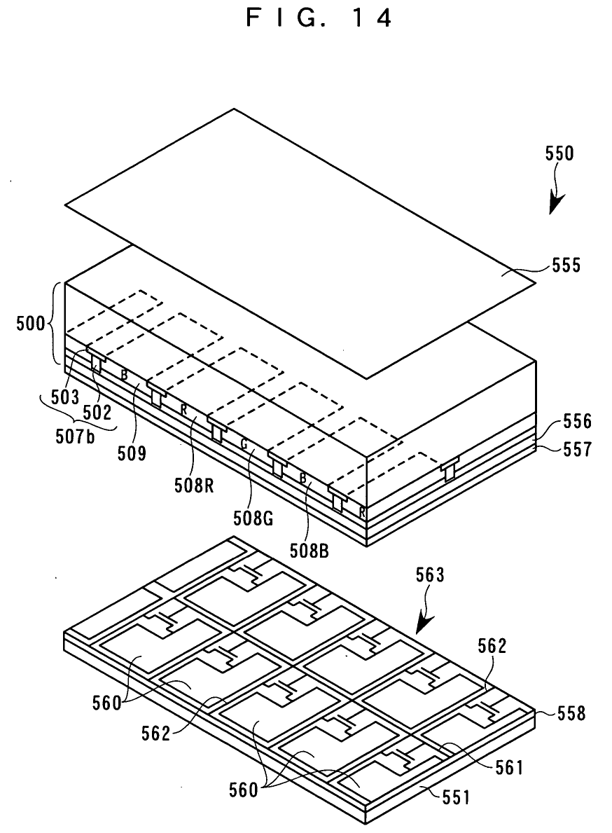

FIG. 14 shows a third example of a liquid crystal device configured by using a color filter 500 to which the present invention is applied and is an exploded perspective view showing a schematic constitution of a transparent TFT (thin film transistor) liquid crystal display.

In this liquid crystal device 550, the color filter 500 is disposed on the upper side in the drawing (the observer side).

This liquid crystal device 550 has a schematic constitution including: the color filter 500; a counter substrate 551 disposed so as to face the color filter 500; an unillustrated liquid crystal layer sandwiched by the color filter 500 and the counter substrate 551; a polarizer 555 disposed on an upper surface (the observer side) of the color filter 500; and a polarizer (not shown) disposed on a lower surface of the counter substrate 551.

On a surface of the protection film 509 of the color filter 500 (a surface on the counter substrate 551 side), an electrode 556 for driving liquid crystal is formed. This electrode. 556 is made of a transparent conductive material such as ITO and becomes an overall electrode covering the entire region where a pixel electrode 560 to be described later is formed. Moreover, an alignment layer 557 is provided, covering a surface opposite to the pixel electrode 560 of the electrode 556.

On a surface of the counter substrate 551, which faces the color filter 500, an insulation layer 558 is formed. On this insulation layer 558, a scan line 561 and a signal line 562 are formed to be orthogonal to each other. In regions surrounded by these scan line 561 and signal line 562, the pixel electrode 560 is formed. In an actual liquid crystal device, an alignment layer is provided on the pixel electrodes 560. However, description thereof is omitted in the drawing.

Moreover, in a notched part of the pixel electrode 560 and the portion surrounded by the scan line 561 and the signal line 562, a thin film transistor 563 including a source electrode, a drain electrode, a semiconductor and a gate electrode is configured. The thin film transistor 563 is turned on and off by application of a signal to the scan line 561 and the signal line 562. Thus, conduction to the pixel electrode 560 can be controlled.

The above-described liquid crystal devices 520, 530 and 550 in the respective examples are the transparent liquid crystal device. However, a reflective liquid crystal device or a translucent reflective liquid crystal device may be obtained by providing a reflective layer or a translucent reflective layer.

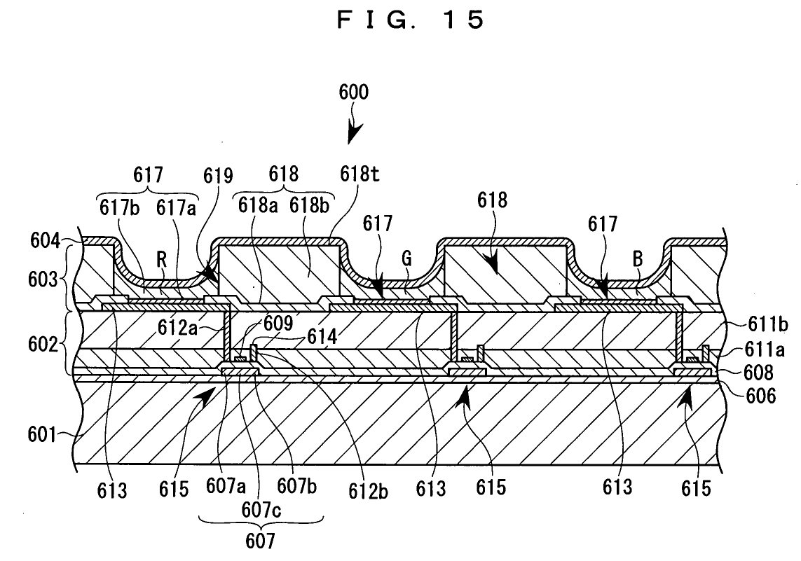

Next, FIG. 15 is a cross-sectional view of a main part of a display region of an organic EL device (hereinafter simply referred to as a display device 600).

This display device 600 has a schematic constitution in which a circuit element part 602, an emitting element part 603 and a cathode 604 are laminated on a substrate (W) 601.

In this display device 600, light emitted from the emitting element part 603 to the substrate 601 side is transmitted through the circuit element part 602 and the substrate 601 and is outputted to the observer side. Meanwhile, light emitted from the emitting element part 603 to the opposite side of the substrate 601 is reflected by the cathode 604 before being transmitted through the circuit element part 602 and the substrate 601 and outputted to the observer side.

An underlayer protection film 606 made of a silicon oxide film is formed between the circuit element part 602 and the substrate 601. On this underlayer protection film 606 (the emitting element part 603 side), an island-shaped semiconductor film 607 made of polysilicon is formed. In regions on the right and left sides of the semiconductor film 607, a source region 607a and a drain region 607b are formed by implanting high-concentration positive ion, respectively. A center portion of the semiconductor film 607, in which no positive ion is implanted, becomes a channel region 607c.

Moreover, in the circuit element part 602, a transparent gate insulation film 608 covering the underlayer protection film 606 and the semiconductor film 607 is formed. In a position corresponding to the channel region 607c of the semiconductor film 607 on the gate insulation film 608, a gate electrode 609 made of Al, Mo, Ta, Ti, W or the like, for example, is formed. On the gate electrode 609 and the gate insulation film 608, transparent first and second interlayer insulation films 611a and 611b are formed. Moreover, contact holes 612a and 612b are formed, communicating with the source and drain-regions 607a and 607b of the semiconductor film 607, respectively, by penetrating the first and second interlayer insulation films 611a and 611b.

On the second interlayer insulation film 611b, a transparent pixel electrode 613 made of ITO or the like is formed by being patterned to have a predetermined shape. This pixel electrode 613 is connected to the source region 607a through the contact hole 612a.

Moreover, a power source line 614 is disposed on the first interlayer insulation film 611a, and this power source line 614 is connected to the drain region 607b through the contact hole 612b.

As described above, thin film transistors 615 for drive, respectively connected to the respective pixel electrodes 613, are formed in the circuit element part 602,

The above-described emitting element part 603 has a schematic constitution including: function layers 617 laminated on the plurality of pixel electrodes 613, respectively; and bank parts 618 which are provided between the respective pixel electrodes 61.3 and function layers 617 and separate the respective function layers 617 from each other.

The emitting element includes these pixel electrodes 613, the function layers 617 and the cathode 604 disposed on the function layers 617. The pixel electrode 613 is formed by being patterned to have an approximately rectangular shape in plane, and the bank parts 618 are formed between the respective pixel electrodes 613.

Each of the bank parts 618 includes: an inorganic bank layer 618a (a first bank layer) formed by using an inorganic material such as SiO, SiO₂ and TiO₂; and an organic bank layer 618b (a second bank layer) with a trapezoidal cross-section, which is laminated on the inorganic bank layer 618a and is formed by resist, such as acrylic resin and polyimide resin, that is excellent in resistance to heat and solvents. A part of this bank part 618 is formed to overlap a peripheral portion of the pixel electrode 613.

Between the respective bank parts 618, opening portions 619 gradually opened upward to the pixel electrodes 613 are formed.

The above-described function layer 617 includes: a hole injection/transport layer 617a formed in a state of being laminated on the pixel electrode 613 in the opening portion 619; and an emitting layer 617b formed on the hole injection/transport layer 617a. Another function layer having another function may be further formed adjacent to this emitting layer 617b. For example, it is also possible to form an electron transport layer.

The hole injection/transport layer 617a has a function of transporting positive holes from the pixel electrode 613 side and injecting the positive holes into the emitting layer 617b. This hole injection/transport layer 617a is formed by ejecting a first composition (a function liquid) including a hole injection/transport layer forming material. As the hole injection/transport layer forming material, for example, a mixture of a polythiophene derivative such as polyethylenedioxythiophene and a polystyrene sulfonate or the like is used.

The emitting layer 617b emits light in red (R), green (G) or blue (B) and is formed by ejecting a second composition (a function liquid) containing an emitting layer forming material (an emitting material). A solvent (a nonpolar solvent) of the second composition is preferably a solvent in which the hole injection/transport layer 617a is insoluble, and includes cyclohexylbenzene, dihydrobenzofuran, trimethylbenzene, tetramethylbenzene or the like may be used therefor, for example. By using such a nonpolar solvent as the second composition of the emitting layer 617b, the emitting layer 617b can be formed without melting the hole injection/transport layer 617a again.

In the emitting layer 617b, the positive holes injected from the hole injection/transport layer 617a are recombined with electrons injected from the cathode 604, and thus light is emitted.

The cathode 604 is formed, covering the entire surface of the emitting element part 603 and plays a role of applying a current to the function layer 617 by being paired up with the pixel electrode 613. A sealing member (not illustrated) is disposed on this cathode 604.

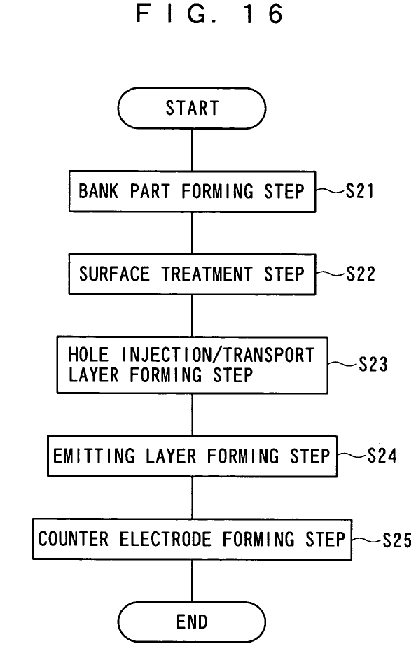

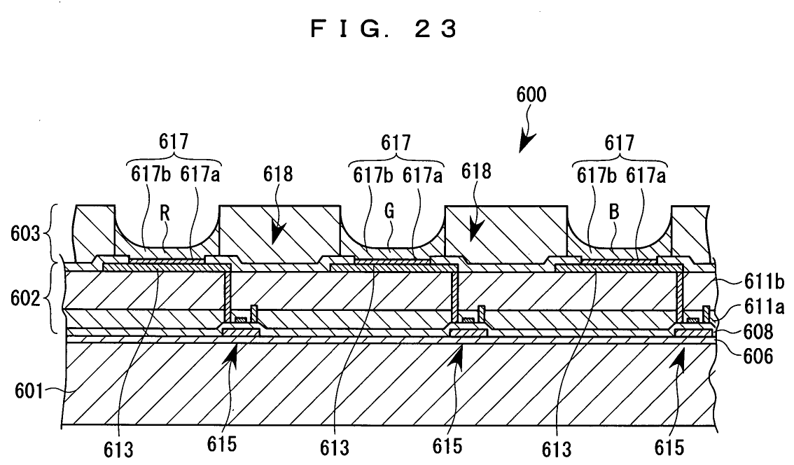

Next, with reference to FIGS. 16 to 24, steps of manufacturing the above-described display device 600 will be described.

As shown in FIG. 16, the display device 600 is manufactured through a bank part formation step (S21), a surface treatment step (S22), a hole injection/transport layer formation step (S23), an emitting layer formation step (S24) and a counter electrode formation step (S25). The manufacturing steps are not limited to those described above as an example. Any of the steps may be removed therefrom, or another step may be added thereto, as required.

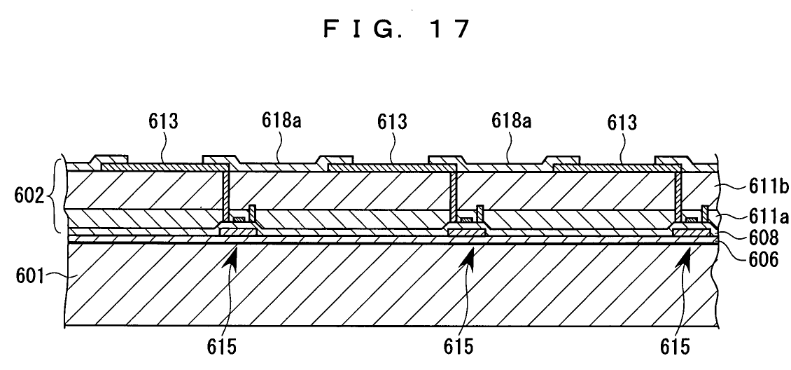

First, as shown in FIG. 17, in the bank part formation step (S21), the inorganic bank layer 618a is formed on the second interlayer insulation film 611b. After an inorganic film is formed in a formation position thereof, this inorganic bank layer 618a is formed by patterning this inorganic film by using a photolithography technology or the like. At this time, a part of the inorganic bank layer 618a is formed so as to overlap the peripheral portion of the pixel electrode 613.

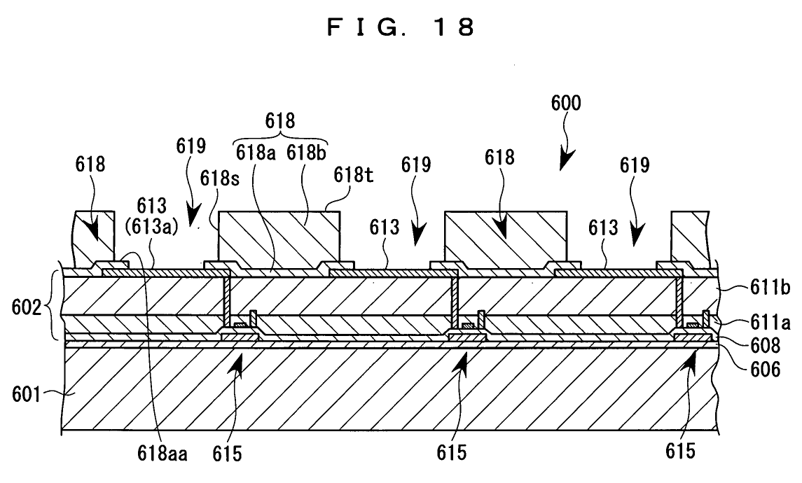

As shown in FIG. 18, once the inorganic bank layer 618a is formed, the organic bank layer 618b is formed on the inorganic bank layer 618a. This organic bank layer 618b is also formed by patterning using the photolithography technology or the like similarly to the inorganic bank layer 618a.

In such a manner, the bank part 618 is formed. Moreover, along with the formation of the bank parts 618, the opening portions 619 that are opened upward to the pixel electrodes 613 are formed between the respective bank parts 618. These opening portions 619 define pixel regions.

In the surface treatment step (S22), a lyophilic treatment and a liquid repellency treatment are performed. Regions subjected to the lyophilic treatment include a first lamination part 618aa of the inorganic bank layer 618a and an electrode surface 613a of the pixel electrode 613. These regions are subjected to the surface treatment so as to be lyophilic by performing plasma processing using oxygen as processing gas, for example. This plasma processing also serves as cleaning of ITO that is the pixel electrode 613, and the like.

Moreover, the liquid repellency treatment is performed on a wall surface 618s of the organic bank layer 618b and an upper surface 618t thereof. Surfaces of the wall surface 618s and the upper surface 618t are fluorinated (are made liquid repellent) by performing plasma processing using methane tetrafluoride as processing gas, for example.

By performing the above-described surface treatment step, the function liquid can be more surely landed onto the pixel regions when forming the function layer 617 by using the function liquid droplet ejection heads 31. Moreover, it is made possible to prevent the function liquid landed onto the pixel regions from overflowing from the opening portions 619.

Through the above-described steps, the display device substrate 600A is obtained. This display device substrate 600A is mounted on the suction table 53 of the liquid droplet ejection apparatus 1 shown in FIG. 1, and the hole injection/transport layer formation step (S23) and the emitting layer formation step (S24) hereinbelow are performed.

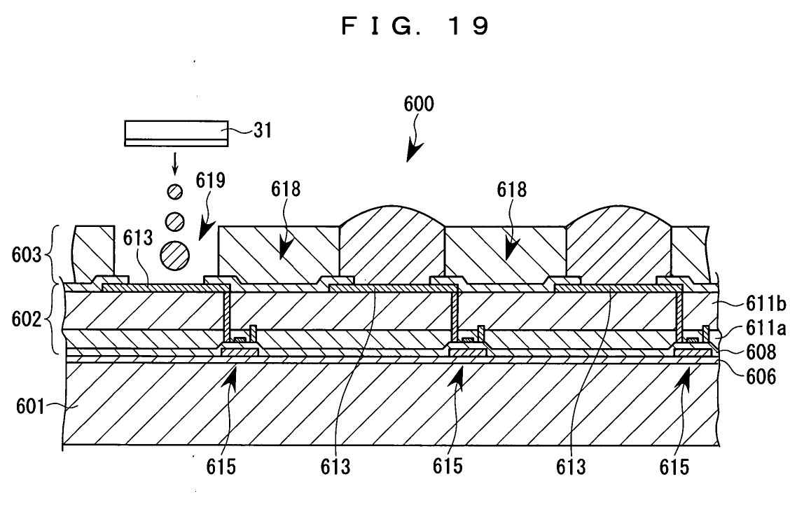

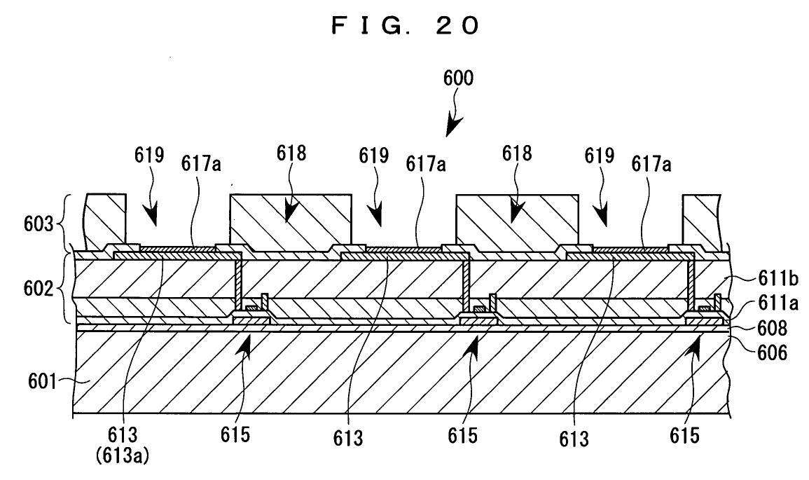

As shown in FIG. 19, in the hole injection/transport layer formation step (S23), the first composition containing the hole injection/transport layer forming material is ejected from the function liquid droplet ejection head 31 into each of the opening portions 619, that is the pixel region. Thereafter, as shown in FIG. 20, a drying treatment and a heat treatment are performed to evaporate a polar solvent contained in the first composition. Thus, the hole injection/transport layer 617a is formed on the pixel electrode 613 (the electrode surface 613a).

Next, the emitting layer formation step (S24) will be described. As described above, in this emitting layer formation step, a nonpolar solvent in which the hole injection/transport layer 617a is insoluble is used as a solvent of the second composition used in forming the emitting layer, in order to prevent the remelting of the hole injection/transport layer 617a.

However, since the hole injection/transport layer 617a has a low affinity to the nonpolar solvent, there is a risk that the hole injection/transport layer 617a and the emitting layer 617b cannot be adhered together or that the emitting layer 617b cannot be evenly applied, even if the second composition containing the nonpolar solvent is ejected on the hole injection/transport layer 617a.

Consequently, in order to improve the affinity of the surface of the hole injection/transport layer 617a to the nonpolar solvent and the emitting layer forming material, it is preferable to perform a surface treatment (a surface modification treatment) before forming the emitting layer. This surface treatment is performed in such a manner that a surface modifying material is applied onto the hole injection/transport layer 617a and this surface modifying material is dried. Here, the surface modifying material is a solvent same as or similar to the nonpolar solvent of the second composition used in the formation of the emitting layer.

By performing this type of treatment, the surface of the hole injection/transport layer 617a is likely to adapt to the nonpolar solvent. In the following step, the second composition containing the emitting layer forming material can be evenly applied to the hole injection/transport layer 617a.

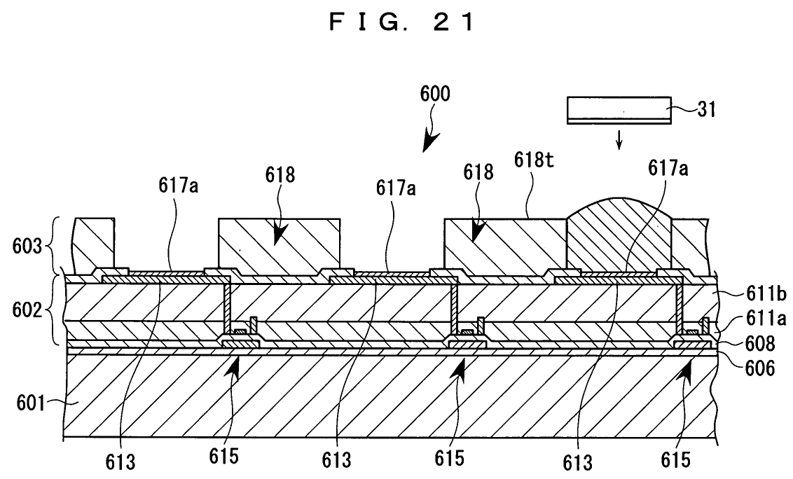

Next, as shown in FIG. 21, as the function liquid, a predetermined amount of the second composition containing an emitting layer forming material corresponding to any of the three colors (blue (B) in the example of FIG. 21) is implanted into the pixel region (the opening portion 619). The second composition ejected into the pixel region spreads over the hole injection/transport layer 617a, and fills up the opening portion 619. Even if the second composition is landed off the pixel region but on the upper surface 618t of the bank part 618, the upper surface 618t is subjected to the liquid repellency treatment as described above. Thus, the second composition is likely to tumble into the opening portion 619.

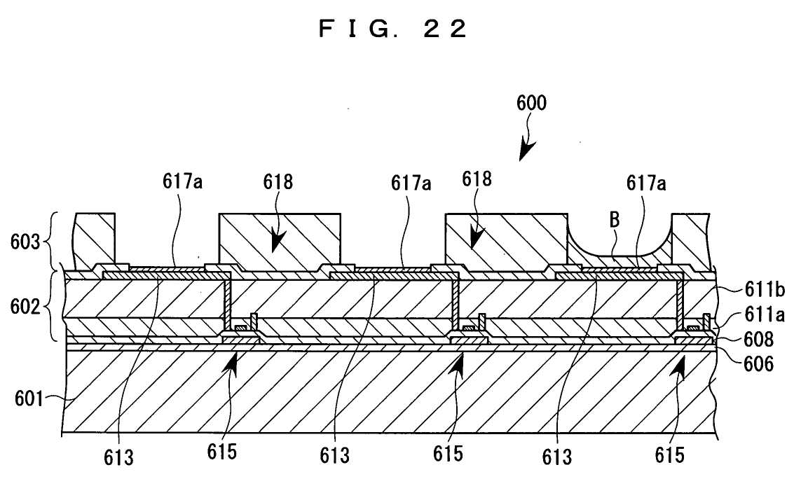

Thereafter, by performing a drying step and the like, the second composition after being ejected is dried to evaporate the nonpolar solvent contained in the second composition. Thus, as shown in FIG. 22, the emitting layer 617b is formed on the hole injection/transport layer 617a. In the case of this drawing, the emitting layer 617b corresponding to blue (B) is formed.

Similarly, by using the function liquid droplet ejection heads 31, steps similar to the above-described step of the emitting layer 617b corresponding to blue (B) are sequentially performed as shown in FIG. 29. Thus, the emitting layers 617b corresponding to the other colors (red (R) and green (G)) are formed. The order of forming the emitting layers 617b is not limited to that shown as an example, and the emitting layers 617b may be formed in any order. For example, it is also possible to determine the order of formation in accordance with the emitting layer formation material. Moreover, as an arrangement pattern of the three colors R, G and B, there are stripe arrangement, mosaic arrangement, delta arrangement and the like.

As described above, the function layer 617, that is, the hole injection/transport layer 617a and the emitting layer 617b are formed on the pixel electrode 613. Thereafter, the processing moves to the counter electrode formation step (S25).

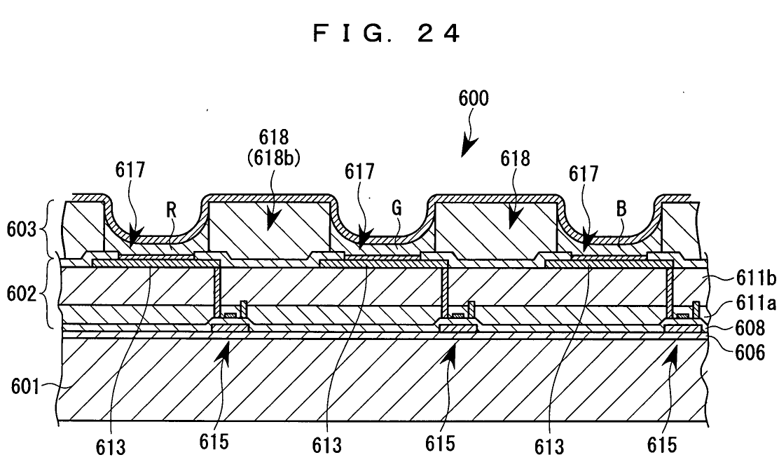

In the counter electrode formation step (S25), as shown in FIG. 24, the cathode 604 (the counter electrode) is formed on the entire surfaces of the emitting layer 617b and the organic bank layer 618b by using, for example, a deposition method, a sputtering method, a CVD method or the like. In the embodiment, this cathode 604 is formed by laminating a calcium layer and an aluminum layer, for example.

At the top of this cathode 604, an Al film or an Ag film as an electrode and a protection layer such as SiO₂ and SiN for preventing oxidization thereof are provided as appropriate.

After the cathode 604 is formed as described above, the top of the cathode 604 is subjected to other processing such as sealing processing of sealing by using a sealing member and wiring processing. Thus, the display device 600 is obtained.

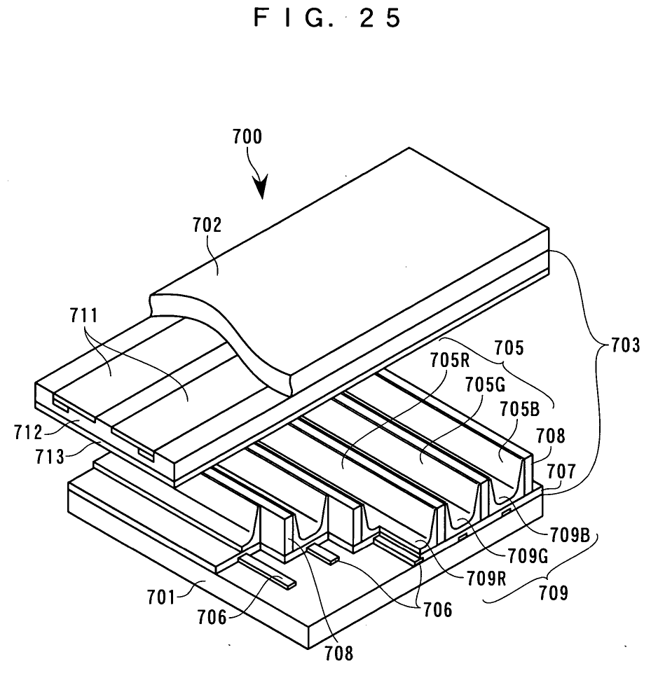

Next, FIG. 25 is an exploded perspective view of a main part of a plasma display panel device (a PDP device; hereinafter simply referred to as a display device 700). FIG. 25 shows the display device 700 in a state of being partially notched.

This display device 700 has a schematic constitution including: first and second substrates 701 and 702, which are disposed to face each other; and a discharge display unit 703 formed between the substrates. The discharge display unit 703 includes a plurality of discharge chambers 705. Among the plurality of discharge chambers 705, three discharge chambers 705 including a red discharge chamber 705R, a green discharge chamber 705G and a blue discharge chamber 705B are disposed as a set to form one pixel.

On an upper surface of the first substrate 701, address electrodes 706 are formed in a striped manner with predetermined intervals therebetween. A dielectric layer 707 is formed so as to cover the upper surfaces of the address electrodes 706 and the first substrate 701. On the dielectric layer 707, partitions 708 are provided upright so as to be positioned between and along the respective address electrodes 706. These partitions 708 include the ones extending on the both sides of and in the width direction of the address electrodes 706 as shown in FIG. 25 and unillustrated ones extending in a direction orthogonal to the address electrodes 706.

Regions separated by these partitions 708 are the discharge chambers 705.

In the discharge chambers 705, phosphors 709 are disposed. The phosphors 709 emit fluorescent light of red (R), green (G) and blue (B). A red phosphor 709R, a green phosphor 709G and a blue phosphor 709B are disposed at bottoms of the red, green and blue discharge chambers 705R, 705G and 705B, respectively.

On a bottom surface of the second substrate 702 in FIG. 25, a plurality of display electrodes 711 are formed in a striped manner at predetermined intervals in a direction orthogonal to the above-described address electrodes 706. A dielectric layer 712 and a protection film 713 made of MgO and the like are formed so as to cover the display electrodes and the bottom surface of the second substrate 702.

The first and second substrates 701 and 702 are attached to each other while facing each other in a state where the address electrodes 706 and the display electrodes 711 are orthogonal to each other. The foregoing address electrodes 706 and the display electrodes 711 are connected to an alternator (not illustrated).

By conducting electricity through the respective electrodes 706 and 711, phosphors 709 are excited to emit light in the discharge display unit 703. Thus, color display is realized.

In this embodiment, the above-described address electrodes 706, display electrodes 711 and phosphors 709 can be formed by using the liquid droplet ejection apparatus 1 shown in FIG. 1. The steps of forming the address electrodes 706 on the first substrate 701 will be described below as an example.

In this case, the following steps are performed in a state where the first substrate 701 is placed on the suction table 53 of the drawing (or imaging) apparatus 1.

First, by using the function liquid droplet ejection heads 31, a liquid material (a function liquid) containing a conductive film wiring forming material is landed as a function liquid onto an address electrode formation region. This liquid material is one obtained by dispersing conductive particles such as metal in a dispersion medium as the conductive film wiring forming material. As the conductive particles, metal particles containing metal, silver, copper, palladium, nickel or the like, conductive polymer and the like are used.

Once the filling of the liquid material is finished for all the address electrode formation regions that are the filling targets, the liquid material after being ejected is dried to evaporate the dispersion medium contained in the liquid material. Thus, the address electrodes 706 are formed.

Incidentally, the formation of the address electrodes 706 is described above as an example. The foregoing display electrodes 711 and phosphors 709 can be also formed through the steps described above.

In the case of forming the display electrodes 711, similarly to the case of the address electrodes. 706, a liquid material (a function liquid) containing a conductive film wiring forming material is landed as a function liquid onto display electrode formation regions.

Moreover, in the case of forming the phosphors 709, a liquid material (a function liquid) containing fluorescent materials corresponding to the respective colors (R, G and B) is ejected as liquid droplets from the liquid droplet ejection heads 31 and landed into the discharge chambers 705 of the corresponding colors.

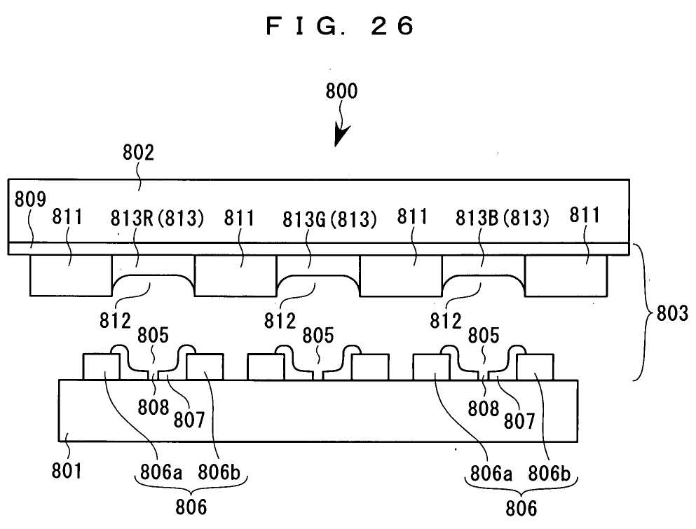

Next, FIG. 26 is a cross-sectional view of a main part of an electron-emitting device (an FED device: hereinafter simply referred to as a display device 800). FIG. 32 shows a cross-section of a part of the display device 800.

This display device 800 has a schematic constitution including: first and second substrates 801 and 802, which are disposed while facing each other; and a field-emission display unit 803 formed between the substrates. The field-emission display unit 803 includes a plurality of electron-emitting parts 805 disposed in a matrix manner.

On an upper surface of the first substrate 801, first and second element electrodes 806a and 806b included in cathode electrodes 806 are formed so as to be orthogonal to each other. Moreover, in portions separated by the first and second element electrodes 806a and 806b, conductive films 807 are formed, each having a gap 808 formed therein. Specifically, by using the first and second element electrodes 806a and 806b and the conductive films 807, the plurality of electron-emitting parts 805 are formed. The conductive film 807 is formed by palladium oxide (PdO) or the like, and the gap 808 is formed by forming or the like after the conductive film 807 is deposited.

On a bottom surface of the second substrate 802, an anode electrode 809 opposite to the cathode electrodes 806 is formed. On a bottom surface of the anode electrode 809, grid-like bank parts 811 are formed. In respective opening portions 812 facing downward and surrounded by the bank parts 811, phosphors 813 are disposed so as to correspond to the electron-emitting parts 805. The phosphors 813 emit fluorescent light of red (R), green (G) and blue (B). In the respective opening portions 812, a red phosphor 813R, a green phosphor 813G and a blue phosphor 813B are disposed in the predetermined pattern described above.

Accordingly, the first and second substrates 801 and 802 thus formed are attached to each other with a minute gap therebetween. In this display device 800, electrons jumping out of the first or second element electrode 806a or 806b serving as a cathode through the conductive film 807 (the gap 808) are hit against the phosphors 813 formed on the anode electrode 809 serving as an anode, and the phosphors 813 are excited to emit light. Thus, color display is realized.

In this case, similarly to the other embodiment, the first and second element electrodes 806a and 806b, the conductive film 807 and the anode electrode 809 can be formed by using the liquid droplet ejection device. 1. In addition, the phosphors 813R, 813G and 813B of the respective colors can be formed by using the liquid droplet ejection apparatus 1.

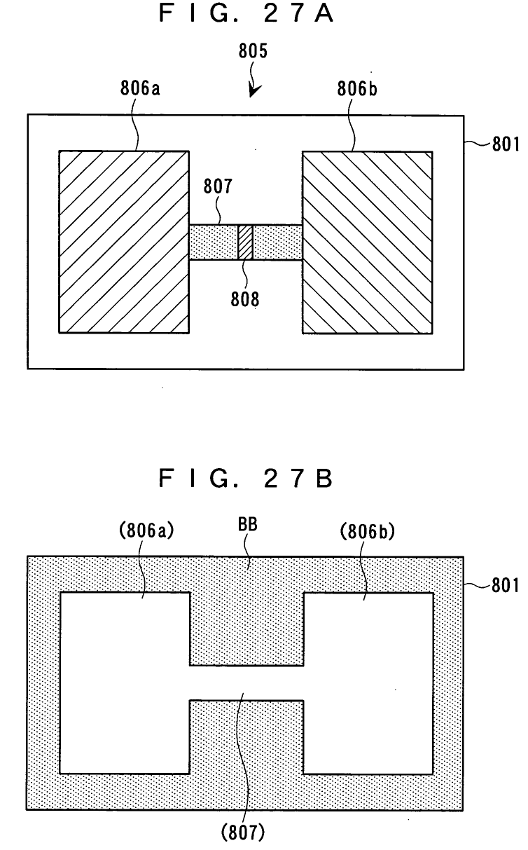

The first and second element electrodes 806a and 806b and the conductive film 807 have planar shapes shown in FIG. 27A. In the case of forming these electrodes and film, as shown in FIG. 27B, a bank part BB is formed (by the photolithography method), leaving areas where the first and second element electrodes 806a and 806b and the conductive film 807 will be formed. Next, in a groove portion formed by the bank part BB, the first and second element electrodes 806a and 806b are formed (by an ink jet method using the liquid droplet ejection apparatus 1), and a solvent is dried to form a film. Thereafter, the conductive film 807 is formed (by the ink jet method using the liquid droplet ejection apparatus 1). Subsequently, after the conductive film 807 is deposited, the bank part BB is removed (by ashing) and the processing moves to the forming described above. Similarly to the case of the organic EL device described earlier, it is preferable to perform the lyophilic treatment for the first and second substrate 801 and 802 and to perform the liquid repellency treatment for the bank parts 811 and BB.

Moreover, as other electrooptic devices, devices for forming a metallic wiring, a lens, a resist, a light diffusion body and the like can be considered. By using the foregoing liquid droplet ejection apparatus 1 for manufacturing various electrooptic devices, the various electrooptic devices can be efficiently manufactured.

As described heretofore, in the suction method and suction apparatus for the function liquid droplet ejection head according to the present invention, the ejector is used as the suction means for the function liquid droplet ejection head. Therefore, the suction of the function liquid droplet ejection head can be efficiently performed while maintaining a proper suction force, without being influenced by the bubbles sucked prior to the function liquid. Therefore, by efficiently discharging the bubbles from the function liquid droplet ejection head, the function liquid consumed during the suction of the function liquid droplet ejection head can be reduced, and the time required for the suction can be minimized. Moreover, the ejector is smaller than the pump and thus the apparatus can be miniaturized.

Moreover, the liquid droplet ejection apparatus according to the present invention includes the suction apparatus described above. Therefore, saving of space in the apparatus can be achieved. Moreover, the suction can be efficiently performed in the case of performing the suction of the function liquid droplet ejection head such as the in case of filling the function liquid droplet ejection head with the function liquid and the case of cleaning the function liquid droplet ejection head.

In the method of manufacturing an electrooptic device, the electrooptic device and the electronic equipment according to the present invention, the liquid droplet ejection apparatus is used for manufacturing. Thus, the amount of the function liquid as well as the time required for the suction of the function liquid droplet ejection head can be reduced. Consequently, the device and equipment described above can be efficiently manufactured.

What is claimed is:

1. A method of sucking a function liquid droplet ejection head, comprising the steps of:
bringing a cap into close contact with a nozzle surface of the function liquid droplet ejection head which ejects function liquid droplets; and
sucking the nozzle surface by an ejector.

2. The method according to claim 1, wherein a flow rate of a working fluid supplied to the ejector is controlled in order to have a constant suction pressure from the cap.

3. The method according to claim 1, wherein a suction pipeline from the cap to the ejector is opened to atmosphere when suction of the function liquid droplet ejection head is finished.

4. An apparatus for sucking a function liquid droplet ejection head in which a cap is brought into close contact with the function liquid droplet ejection head which ejects a function liquid, said sucking being made through the cap, said apparatus comprising:
an ejector which sucks all nozzles of the function liquid droplet ejection head in a state of being in fluid-flow communication with the cap; and
working fluid supply means for supplying the ejector with a working fluid.

5. The apparatus according to claim 4, wherein the ejector is interposed near the cap.

6. The apparatus according to claim 4, further comprising:
pressure detection means for detecting a pressure in a suction pipeline connecting the cap to a suction port of the ejector;
a flow rate regulating valve for regulating a flow rate of the working fluid supplied to the ejector, said valve being interposed in a working fluid supply pipeline connecting the working fluid supply means to a supply port of the ejector; and
first control means for controlling the flow rate regulating valve based on a detection result obtained by the pressure detection means.

7. The apparatus according to claim 6, wherein the first control means gradually closes the flow rate regulating valve when suction of the function liquid droplet ejection head is finished.

8. The apparatus according to claim 6, further comprising:
a suction pipeline gate valve which is interposed in the suction pipeline and which opens/closes the suction pipeline,
wherein the first control means closes the flow rate regulating valve and the suction pipeline gate valve when the suction of the function liquid droplet ejection head is finished.

9. The apparatus according to claim 8,
wherein the suction pipeline gate valve is made of a three-way valve having an atmosphere releasing port, and
wherein the first control means opens the atmosphere releasing port simultaneously with closing of the suction pipeline gate valve and opens the flow rate regulating valve again.

10. The apparatus according to claim 4, further comprising:
a storage tank which stores a function liquid in advance and is connected to a discharge port of the ejector by a discharge pipeline,
wherein the working fluid supply means is made up of a pump and is connected to the storage tank through a circulating pipeline to supply the function liquid as a working fluid.

11. The apparatus according to claim 10,
wherein a circulating pipeline gate valve made up of a three-way valve having an atmosphere releasing port is interposed in the circulating pipeline connecting the working fluid supply means to the storage tank, and
wherein the suction apparatus further comprises second control means for closing the circulating pipeline gate valve and opening the atmosphere releasing port of the circulating pipeline gate valve when suction of the function liquid droplet ejection head is finished.

12. The apparatus according to claim 4, wherein a plurality of function liquid droplet ejection heads are provided, and a plurality of caps, ejectors and suction pipelines are provided, respectively, in accordance with the plurality of function liquid droplet ejection heads.

13. A liquid droplet ejection apparatus, comprising:
the suction apparatus for a function liquid droplet ejection head according to claim 4; and
function liquid droplet ejection heads ejecting a function liquid onto a workpiece.

14. A method of manufacturing an electrooptic device, wherein a film formation part is formed on a workpiece by a function liquid, using the liquid droplet ejection apparatus according to claim 13.

15. An electrooptic device, wherein a film formation part is formed on a workpiece by a function liquid, using the liquid droplet ejection apparatus according to claim 13.

16. An electronic equipment, wherein the electrooptic device according to claim 15 is mounted.
